(19) United States
(12) Patent Application Publication
(10) Pub. No.: US 2022/0128915 A1
(43) Pub. Date: Apr. 28, 2022

(54) TONER

(71) Applicant: CANON KABUSHIKI KAISHA, Tokyo (JP)

(72) Inventors: Takayuki Toyoda, Shizuoka (JP); Akane Masumoto, Shizuoka (JP); Kenji Ookubo, Shizuoka (JP); Taku Shimoda, Tokyo (JP); Masashi Kawamura, Kanagawa (JP); Yu Yoshida, Shizuoka (JP)

(21) Appl. No.: 17/502,755

(22) Filed: Oct. 15, 2021

(30) Foreign Application Priority Data
Oct. 23, 2020 (JP) 2020-178378

(51) Int. Cl. G03G 9/087; G03G 9/097

(52) U.S. Cl. CPC G03G 9/08711; G03G 9/08755; G03G 9/08797; G03G 9/08782; G03G 9/09791; G03G 9/08773

(57) ABSTRACT

A toner comprising a toner particle, wherein the toner particle comprises a binder resin, a resin A, a wax, and a fatty acid metal salt, the resin A has a substituted or unsubstituted silyl group in a molecule, and a substituent of the substituted silyl group is at least one selected from the group consisting of an alkyl group having 1 or more carbon atoms, an alkoxy group having 1 or more carbon atoms, a hydroxy group, a halogen atom, and an aryl group having 6 or more carbon atoms.

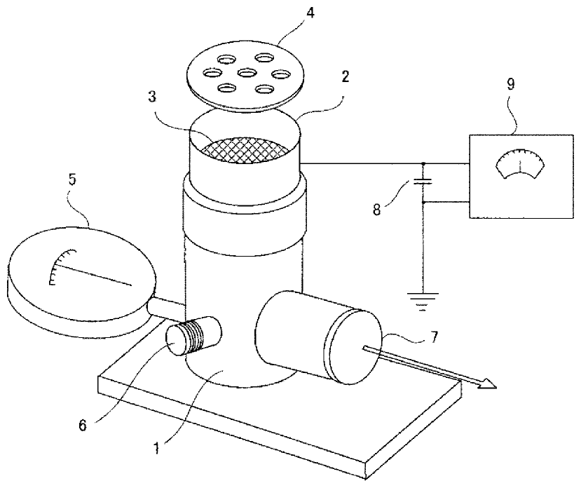

### BACKGROUND OF THE INVENTION

### Field of the Invention

The present disclosure relates to a toner for use in recording methods using electrophotography and the like.

### Description of the Related Art

In recent years, as image-forming apparatuses such as copiers and printers are used for more diverse purposes and in more diverse environments, higher speeds and longer service lives are being required. In particular, increased process speeds and longer service lives have spurred demand for toners with superior fixing performance and flowability.

According to Japanese Patent Application Publication No. 2018-151513, a wax dispersion effect is obtained in a toner and the low-temperature fixability and heat-resistant storage stability of the toner are improved by using an ester wax as a release agent and a hybrid resin comprising a polycondensation resin unit and an addition polymer resin unit as a wax dispersant.

In Japanese Patent Application Publication No. H07-239573, offset resistance is improved by including as a binder resin a vinyl resin obtained by copolymerizing a vinyl monomer with a silane coupling agent having an unsaturated double bond and an alkoxysilyl group.

In Japanese Patent Application Publication No. 2007-79304, the flowability of a toner is improved by externally adding an external additive and a specific fatty acid metal salt to a toner core.

### SUMMARY OF THE INVENTION

However, it has been found that with the toner described in Japanese Patent Application Publication No. 2018-151513, the offset resistance is inadequate because the wax dispersant increases the compatibility between the wax and the binder resin, thereby suppressing exudation of the wax during fixing.

It has also been found that with the toner described in Japanese Patent Application Publication No. H07-239573, the wax may be exuded onto the toner surface during long-term use, thereby detracting from flowability and causing problems with solid followability.

Furthermore, it has been found that with the toner described in Japanese Patent Application Publication No. 2007-79304, there is still room for improvement in terms of maintaining flowability because the externally added fatty acid metal salt becomes detached from the toner core during long-term use.

The present disclosure provides a toner with excellent fixing performance and excellent flowability even during long-term use.

The present disclosure relates to a toner comprising a toner particle, wherein

the toner particle comprises a binder resin, a resin A, a wax, and a fatty acid metal salt,

the resin A has a substituted or unsubstituted silyl group in a molecule, and

a substituent of the substituted silyl group is at least one selected from the group consisting of an alkyl group having 1 or more carbon atoms, an alkoxy group having 1 or more carbon atoms, a hydroxy group, a halogen atom, and an aryl group having 6 or more carbon atoms.

The present disclosure can provide a toner with excellent fixing performance and excellent flowability even during long-term use.

Further features of the present invention will become apparent from the following description of exemplary embodiments with reference to the attached drawing.

### BRIEF DESCRIPTION OF THE DRAWINGS

The FIGURE shows an apparatus for measuring charge quantity.

### DESCRIPTION OF THE EMBODIMENTS

Embodiments of the invention are explained in detail below, but the disclosure is not limited to these embodiments.

Unless otherwise specified, descriptions of numerical ranges such as “at least A but not more than B” or “from A to B” in the present disclosure describe numerical ranges that include the minimum and maximum values at either end of the range.

The present disclosure provides a toner comprising a toner particle, wherein

the toner particle comprises a binder resin, a resin A, a wax, and a fatty acid metal salt,

the resin A has a substituted or unsubstituted silyl group in the molecule, and

the substituent of the substituted silyl group is at least one selected from the group consisting of an alkyl group having 1 or more carbon atoms, an alkoxy group having 1 or more carbon atoms, a hydroxy group, a halogen atom, and an aryl group having 6 or more carbon atoms.

The inventors discovered that a toner with excellent fixing performance and excellent flowability even during long-term use could be provided by adopting the above toner configuration.

The inventors believe that the reasons for this are as follows.

With conventional toners having excellent low-temperature fixability, the composition of the toner surface is altered by the effects of stress including heat and shock within the developing device during long-term use, and the wax component is exuded onto the toner surface, detracting from flowability. When a wax dispersant or the like is used to suppress wax exudation, on the other hand, offset resistance becomes a problem because wax exudation is also suppressed during fixing.

The toner of the present disclosure has a toner particle comprising a binder resin, a resin A, a fatty acid metal salt, and a wax, and the resin A has a substituted or unsubstituted silyl group in the molecule. It is thought that a composite of the resin A and the fatty acid metal salt forms as a result of interactions between silicon atoms in the silyl groups of the resin A and oxygen atom segments adjacent to the metal of the fatty acid metal salt and/or interactions between oxygen atom segments in the substituents of the silyl groups in the resin A and metal segments of the fatty acid metal salt. The fatty acid metal salt and the wax also have high affinity due to their similar structures, and it is thought that the composite of the resin A and the fatty acid metal salt serves to uniformly disperse the wax in the toner particle, thereby stabilizing the wax. It is thought exudation of the wax onto the toner surface during long-term use is suppressed as a result, preventing a drop in flowability.

Because the interactions between the resin A and the fatty acid metal salt are not covalent binding, moreover, they are interrupted by increased molecular mobility due to heat during fixing. As a result, it is thought that the wax that had been stabilized by the composite of the resin A and the fatty acid salt can then be exuded onto the toner surface, providing a release effect and achieving offset resistance.

Hereinafter, the features and factors of the present disclosure will be described in detail.

### <Resin A>

The toner core particle includes the resin A. The resin A has (i) a substituted or unsubstituted silyl group in the molecule thereof, and (ii) a substituent of the substituted silyl group is at least one selected from the group consisting of an alkyl group having 1 or more carbon atoms, an alkoxy group having 1 or more carbon atoms, a hydroxy group, a halogen atom, and an aryl group having 6 or more carbon atoms.

The number of carbon atoms in the alkyl group is preferably from 1 to 20, and more preferably from 1 to 4.

The number of carbon atoms in the alkoxy group is preferably from 1 to 20, more preferably from 1 to 4, further preferably from 1 to 3, and particularly preferably 1 or 2.

The number of carbon atoms in the aryl group is preferably from 6 to 14, and more preferably from 6 to 10.

The resin A is not limited as long as the above conditions (i) and (ii) are satisfied. Examples of the resin A include a resin with a chemically bonded silane coupling agent or the like, a polymer of an organosilicon compound, and a hybrid resin thereof. More specific examples include resins obtained by modifying a polyester resin, a vinyl resin, a polycarbonate resin, a polyurethane resin, a phenol resin, an epoxy resin, a polyolefin resin, or a styrene acrylic resin with a silane coupling agent and/or a silicone oil or the like.

The resin A preferably has the structure represented by the following formula (1):

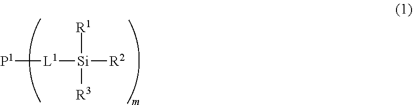

In formula (1), P¹ represents a polymer segment, L¹ represents a single bond or divalent linking group, each of R¹ to R³ independently represents a hydrogen atom, a halogen atom, an alkyl group having 1 or more carbon atoms, an alkoxy group having 1 or more carbon atoms, an aryl group having 6 or more carbon atoms or a hydroxy group, m represents a positive integer, and when m is at least 2, each of the multiple L's, each of multiple R's, each of multiple R²s and each of multiple R³s may be the same or different.

When the resin A has the structure represented by the above formula (1), interactions with the fatty acid metal salt are stronger and the suppression effect against wax exudation during long-term use is increased.

Preferably at least one of R¹ to R³ in the formula (1) represents an alkoxy group having 1 or more carbon atoms or a hydroxy group. More preferably, each of R¹ to R³ in the formula (1) independently represents an alkoxy group having 1 or more carbon atoms or a hydroxy group. It is thought that interactions with the metal salt of the fatty acid metal salt are even stronger in the presence of an alkoxy group having 1 or more carbon atoms or a hydroxy group, and wax exudation can be further suppressed during long-term use.

Of the above substituents, the alkyl groups preferably have carbon numbers of 1 to 20, or more preferably 1 to 4. The alkoxy groups preferably have carbon numbers of 1 to 20, or more preferably 1 to 4, or still more preferably 1 to 3, or especially 1 or 2. The aryl groups preferably have carbon numbers of 6 to 14, or more preferably 6 to 10. Within this range, better interactions with the fatty acid metal salt are obtained.

The content of silicon atoms in the resin A is preferably 0.02 mass % to 10.00 mass %. If it is at least 0.02 mass %, interactions with the fatty acid salt occur more favorably. If it is not more than 10.00 mass %, this makes the resin A more compatible with the binder resin, so that the complex of the resin A and the fatty acid metal salt can disperse the wax more uniformly in the toner particle. The content of silicon atoms in the resin A is more preferably 0.10 mass % to 5.00 mass %, or still more preferably 0.15 mass %, to 2.00 mass %.

The content of silicon atoms in the resin A can be controlled by adjusting the amount of a silicon compound used in manufacturing the resin A.

The content of the resin A in the toner particle is preferably 0.05 mass % to 90.00 mass %, or more preferably 0.05 mass % to 10.00 mass %. If the content of the resin A in the toner is at least 0.05 mass %, the wax disperses better in the toner, while low temperature fixability is improved if it is not more than 90.00 mass %.

In order to convert one or more of R¹ to R³ in the formula (1) into a hydroxy group, the resin A in which one or more of R¹ to R³ is an alkoxy group may be hydrolyzed to convert the alkoxy group into a hydroxy group.

Any hydrolysis method may be used and an example thereof is described hereinbelow.

The resin A in which at least one of R¹ to R³ in the formula (1) is an alkoxy group is dissolved or suspended in a suitable solvent (which may be a polymerizable monomer), and the pH is adjusted to an acidic value with an acid or an alkali, followed by hydrolysis.

Also, hydrolysis may be caused during the production of the toner particle.

P¹ in the formula (1) is not particularly limited, but may be a polyester resin segment, vinyl resin segment, styrene-acrylic resin segment, polyurethane resin segment, polycarbonate resin segment, phenol resin segment, polyolefin resin segment or the like.

From the standpoint of affinity for the binder resin, P¹ preferably includes a polyester resin segment or a styrene-acrylic resin segment. For example, it may also be a hybrid resin segment of a polyester resin and a styrene-acrylic resin.

The weight-average molecular weight (Mw) of the resin A is preferably 3,000 to 100,000, or more preferably 3,000 to 30,000. If the Mw of the resin A is at least 3,000, wax exudation can be further suppressed, while if it is not more than 100,000, compatibility with the binder resin is further increased, and the wax can be better dispersed.

From the viewpoints of charge rising performance and storage stability, the weight average molecular weight (Mw) of the resin A is preferably from 3,000 to 100,000, and more preferably from 3,000 to 30,000. The Mw of the resin A can be controlled by various methods depending on the type of the contained resin. For example, when a polyester resin is contained, the control can be performed by adjusting the charge ratio of a dialcohol and a dicarboxylic acid, which are monomers thereof, or adjusting the polymerization time. Where a styrene acrylic resin is contained, the control can be performed by adjusting the ratio of the vinyl monomer, which is the monomer thereof, to the polymerization initiator, or adjusting the reaction temperature.

The polyester resin is not particularly limited, but is preferably a condensate of a dialcohol and a dicarboxylic acid. For example, a polyester resin having a structure represented by the following formula (6) and at least one structure (a plurality of structures can be selected) selected from the group consisting of structures represented by the following formulas (7) to (9) is preferred. Another example is a polyester resin having a structure represented by the following formula (10).

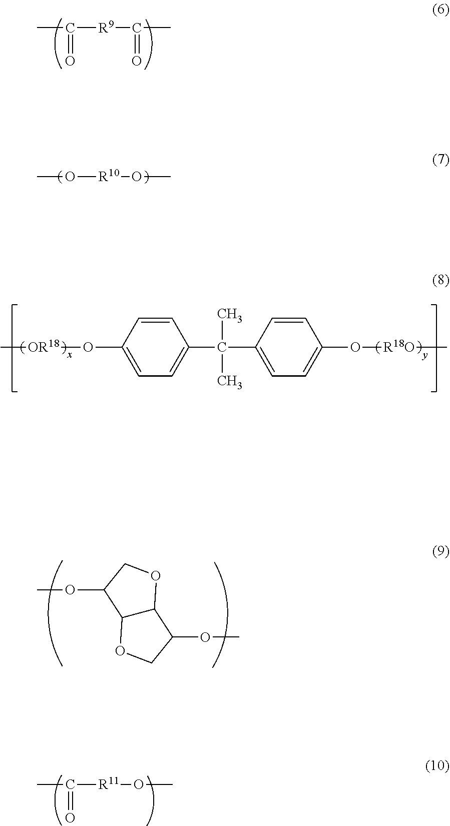

Where, R⁹ represents an alkylene group, an alkenylene group, or an arylene group; R¹⁰ represents an alkylene group or a phenylene group; R¹⁸ represents an ethylene group or a propylene group, x and y are each an integer of 0 or more, and the average value of x+y is from 2 to 10; R¹¹ represents an alkylene group or an alkenylene group.

Examples of the alkylene group (preferably having from 1 to 12 carbon atoms) for R⁹ in the formula (6) include a methylene group, an ethylene group, a trimethylene group, a propylene group, a tetramethylene group, a hexamethylene group, a neopentylene group, a heptamethylene group, an octamethylene group, a nonamethylene group, a decamethylene group, an undecamethylene group, a dodecamethylene group, and 1,3-cyclopentylene, 1,3-cyclohexylene, and 1,4-cyclohexylene groups.

Examples of the alkenylene group (preferably having from 2 to 4 carbon atoms) for R⁹ in the formula (6) include a vinylene group, a propenylene group and a 2-butenylene group.

Examples of the arylene group (preferably having from 6 to 12 carbon atoms) for R⁹ in the formula (6) include a 1,4-phenylene group, a 1,3-phenylene group, a 1,2-phenylene group, a 2,6-naphthylene group, a 2,7-naphthylene group and a 4,4′-biphenylene group.

R⁹ in the formula (6) may be substituted with a substituent. In this case, examples of the substituent include a methyl group, a halogen atom, a carboxy group, a trifluoromethyl group, and a combination thereof.

Examples of the alkylene group (preferably having from 1 to 12 carbon atoms) for R¹⁰ in the formula (7) include a methylene group, an ethylene group, a trimethylene group, a propylene group, a tetramethylene group, a hexamethylene group, a neopentylene group, a heptamethylene group, an octamethylene group, a nonamethylene group, a decamethylene group, an undecamethylene group, a dodecamethylene group, and 1,3-cyclopentylene, 1,3-cyclohexylene, and 1,4-cyclohexylene groups.

Examples of the phenylene group for R¹⁰ in the formula (7) include a 1,4-phenylene group, a 1,3-phenylene group, and a 1,2-phenylene group.

R¹⁰ in the formula (7) may be substituted with a substituent. In this case, examples of the substituent include a methyl group, an alkoxy group, a hydroxy group, a halogen atom, and a combination thereof.

Examples of the alkylene group (preferably having from 2 to 12 carbon atoms) for R¹¹ in the formula (10) include a methylene group, an ethylene group, a trimethylene group, a propylene group, a tetramethylene group, a hexamethylene group, a neopentylene group, a heptamethylene group, an octamethylene group, a nonamethylene group, a decamethylene group, an undecamethylene group, a dodecamethylene group, and a 1,4-cyclohexylene group.

Examples of the alkenylene group (preferably having from 1 to 40 carbon atoms) for R¹¹ in the formula (10) include a vinylene group, a propenylene group, a butenylene group, a butadienylene group, a pentenylene group, a hexenylene group, a hexadienylene group, a heptenylene group, an octanylene group, a decenylene group, an octadecenylene group, an eicosenylene group, and a triacontenylene group. These alkenylene groups may have any of a linear, branched and cyclic structure. Further, the double bond may be at any position, as long as there is at least one double bond.

R¹¹ in the formula (10) may be substituted with a substituent. In this case, examples of the substituent that may be used for substitution include an alkyl group, an alkoxy group, a hydroxy group, a halogen atom, and a combination thereof.

The styrene-acrylic resin segment is not particularly limited and may consisting solely of a styrene-acrylic resin or may be a block copolymer or graft copolymer of a styrene-acrylic resin with another polymer, or a mixture of these.

A styrene-acrylic resin here means a copolymer of a styrene monomer with at least one monomer selected from the group consisting of the acrylic acid monomers and methacrylic acid monomers.

Examples of the styrene monomer include styrene, alpha-methyl styrene, beta-methyl styrene, o-methyl styrene, m-methyl styrene, p-methyl styrene, 2,4-dimethyl styrene, and divinyl benzene. One kind of styrene monomer may be used, or a combination of two or more kinds selected from these may be used.

Examples of the acrylic acid monomers include acrylic acid alkyl esters such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, and n-nonyl acrylate; acrylic acid diesters such as diethylene glycol diacrylate, triethylene glycol diacrylate, tetraethylene glycol diacrylate, polyethylene glycol diacrylate, and 1,6-hexanediol diacrylate; and acrylic acid and the like.

Examples of the methacrylic acid monomers include methacrylic acid alkyl esters such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, and n-nonyl methacrylate; and methacrylic acid and the like.

One kind of acrylic acid monomer or methacrylic acid monomer or a combination of two or more kinds selected from these may be used.

The styrene-acrylic resin segment preferably comprises at least one selected from the group consisting of the styrene-acrylic acid alkyl ester copolymers and styrene-methacrylic acid alkyl ester copolymers.

The ratio of the styrene monomer as a percentage of the total monomers forming the styrene-acrylic resin is preferably from 45 mass % to 80 mass %. The ratio of at least one monomer selected from the group consisting of the acrylic acid monomers and methacrylic acid monomers (for example, at least one selected from the group consisting of the acrylic acid alkyl esters and methacrylic acid alkyl esters) is preferably from 20 mass % to 50 mass %.

Examples of the divalent linking group represented by L¹ in the formula (1) include, but are not limited to, structures represented by the following formulas (2) to (5).

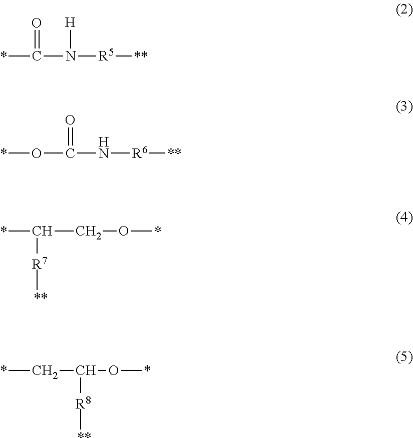

R⁵ in the formula (2) represents a single bond, an alkylene group or an arylene group. (*) represents a binding segment to P¹ in the formula (1), and (**) represents a binding segment to a silicon atom in the formula (1). R⁶ in the formula (3) represents a single bond, an alkylene group or an arylene group. (*) represents a binding segment to P¹ in the formula (1), and (**) represents a binding segment to a silicon atom in the formula (1). R⁷ and R⁸ in the formulas (4) and (5) each independently represent an alkylene group, an arylene group, or an oxyalkylene group. (*) represents a binding segment to P¹ in the formula (1), and (**) represents a binding segment to a silicon atom in the formula (1).

The structure represented by the formula (2) is a divalent linking group including an amide bond.

The linking group can be formed, for example, by reacting a carboxy group in the resin with an aminosilane.

The aminosilane is not particularly limited, and examples thereof include γ-aminopropyltriethoxysilane, γ-aminopropyltrimethoxysilane, N-β-(aminoethyl) γ-aminopropyltrimethoxysilane, N-β-(aminoethyl) γ-aminopropylmethyldimethoxysilane, N-phenyl γ-aminopropyltriethoxysilane, N-phenyl γ-aminopropyltrimethoxysilane, N-β-(aminoethyl) γ-aminopropyltriethoxysilane, N-6-(aminohexyl) 3-aminopropyltrimethoxysilane, 3-aminopropyltrimethylsilane, 3-aminopropylsilicon and the like.

The alkylene group (preferably having from 1 to 12 carbon atoms) in R⁵ is not particularly limited, and may be, for example, an alkylene group including an —NH— group.

The arylene group (preferably having from 6 to 12 carbon atoms) in R⁵ is not particularly limited, and may be, for example, an arylene group including a hetero atom.

The structure represented by the formula (3) is a divalent linking group including a urethane bond.

The linking group can be formed, for example, by reacting a hydroxy group in the resin with an isocyanate silane.

The isocyanate silane is not particularly limited, and examples thereof include 3-isocyanatopropyltrimethoxysilane, 3-isocyanatopropylmethyldimethoxysilane, 3-isocyanatopropyldimethylmethoxysilane, 3-isocyanatopropyltriethoxysilane, 3-isocyanatopropylmethyldiethoxysilane, 3-isocyanatopropyldimethylethoxysilane and the like.

The alkylene group (preferably having from 1 to 12 carbon atoms) in R⁶ is not particularly limited, and may be, for example, an alkylene group including an —NH— group.

The arylene group (preferably having from 6 to 12 carbon atoms) in R⁶ is not particularly limited, and may be, for example, an arylene group including a hetero atom.

The structure represented by the formula (4) or (5) is a divalent linking group including a bond grafted to an ester bond in the resin.

The linking group is formed by, for example, an epoxysilane insertion reaction.

The term “epoxysilane insertion reaction” refers to a reaction including a step of causing an insertion reaction of an epoxy group of epoxysilane into an ester bond contained in a main chain in a resin. Further, the term “insertion reaction” as used herein is described in “Journal of Synthetic Organic Chemistry, Japan”, Vol. 49, No. 3, p. 218, 1991, as “an insertion reaction of an epoxy compound into an ester bond in a polymer chain”.

The reaction mechanism of the epoxy silane insertion reaction can be represented by the model diagram below.

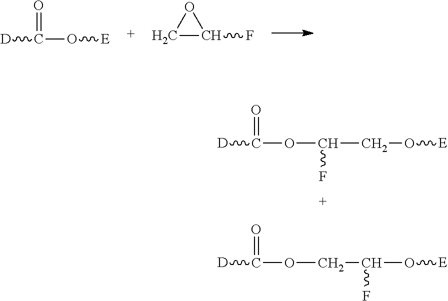

In the above diagram, D and E indicate the constituent parts of the resin, and F indicates the constituent part of the epoxy compound.

Two kinds of compounds are formed due to α-cleavage and β-cleavage in the ring opening of the epoxy group in the diagram. In both cases, a compound is obtained in which an epoxy group is inserted into an ester bond in a resin, in other words, a compound in which a constituent part of the epoxy compound other than the epoxy segment is grafted to the resin.

The epoxysilane is not particularly limited, and may be, for example, β-(3,4-epoxycyclohexyl)ethyltrimethoxysilane, γ-glycidoxypropyltrimethoxysilane, γ-glycidoxypropylmethyldiiethoxysilane and the like.

The alkylene group (preferably having from 1 to 12 carbon atoms) in R⁷ and R⁸ is not particularly limited, and may be, for example, an alkylene group including an —NH— group.

The arylene group (preferably having from 6 to 12 carbon atoms) in R⁷ and R⁸ is not particularly limited, and may be, for example, an arylene group including a hetero atom.

The oxyalkylene group (preferably having from 1 to 12 carbon atoms) in R⁷ and R⁸ is not particularly limited, and may be, for example, an oxyalkylene group including an —NH— group.

<Binder Resin>

The toner particle comprises a binder resin. The content of the binder resin in the toner particle is preferably 60 mass % to 90 mass %.

The following resins for example may be used as the binder resin:

homopolymers of styrene and substituted styrene, such as polystyrene and polyvinyl toluene;

styrene copolymers such as styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-dimethyl aminoethyl acrylate copolymer, styrene-methyl methacrylate copolymer, styrene-ethyl methacrylate copolymer, styrene-butyl methacrylate copolymer, styrene-dimethyl aminoethyl methacrylate copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-maleic acid copolymer, and styrene-maleic acid ester copolymer;

and polymethyl methacrylate, polybutyl methacrylate, polyvinyl acetate, polyethylene, polypropylene, polyvinyl butyral, silicone resin, polyester resin, polyamide resin, epoxy resin, polyacrylic resin, rosin, modified rosin, terpene resin, phenol resin, aliphatic and alicyclic hydrocarbon resins, and aromatic petroleum resins.

One of these alone or a mixture may be used.

Of these, preferably the content of a styrene-acrylic resin in the binder resin is at least 50 mass %, and P¹ in the formula (1) represents a styrene-acrylic resin segment.

It is also desirable if the content of a polyester resin in the binder resin is at least 50 mass %, and P¹ in formula (1) represents a polyester resin segment. Differences in the toner charge quantity due to environmental difference can be minimized if the resin type of the binder resin matches the segment represented by P¹ in formula (1).

The inventors believe that the mechanism for this is as follows.

If the resin A is unevenly distributed and localized in the binder resin, the charge quantity of the toner under low-temperature, low-humidity conditions tends to be much greater than the charge quantity of the toner under high-temperature, high-humidity conditions. If the resin type of the binder resin matches the segment represented by P¹ in formula (1), the binder resin and the resin A have greater affinity, and differences in the charge quantity due to environmental differences should be less because the resin A is more uniformly dispersed in the toner.

<Crosslinking Agent>

In order to control the molecular weight of the binder resin, a crosslinking agent may be added during the polymerization of the polymerizable monomer.

For example, the following compounds can be used as the crosslinking agent, but these examples are not limiting.

Ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene glycol #200, #400, #600 diacrylate, dipropylene glycol diacrylate, polypropylene glycol diacrylate and polyester type diacrylate (MANDA, manufactured by Nippon Kayaku Co., Ltd.), and the above acrylates converted to methacrylates.

The amount of the crosslinking agent to be added is preferably from 0.001 parts by mass to 15.0 parts by mass based on 100 parts by mass of the polymerizable monomer.

<Wax>

The toner particle comprises a wax. For example, a wax such as the following or a combination of two or more of these may be used, but the wax is not limited to these.

Examples include esters of monohydric alcohols and aliphatic monocarboxylic acids or esters of monovalent carboxylic acids and aliphatic monoalcohols, such as behenyl behenate, stearyl stearate, and palmityl palmitate;

esters of dihydric alcohols and aliphatic monocarboxylic acids or esters of divalent carboxylic acids and aliphatic monoalcohols, such as dibehenyl sebacate, hexanediol dibehenate, ethylene glycol distearate, octanediol distearate, ethylene glycol dimontanate, and ethylene glycol dimyristate;

esters of trihydric alcohols and aliphatic monocarboxylic acids or esters of trivalent monocarboxylic acids and aliphatic monoalcohols, such as glycerin tribehenate;

esters of tetrahydric alcohols and aliphatic monocarboxylic acids or esters of tetravalent carboxylic acids and aliphatic monoalcohols, such as pentaerythritol tetrastearate and pentaerythritol tetrapalmitate;

esters of hexahydric alcohols and aliphatic monocarboxylic acids or esters of hexavalent carboxylic acids and aliphatic monoalcohols, such as dipentaerythritol hexastearate and dipentaerythritol hexapalmitate;

esters of polyhydric alcohols and aliphatic monocarboxylic acids or esters of polyvalent carboxylic acids and aliphatic monoalcohols, such as polyglycerin behenate;

natural ester waxes such as carnauba wax and rice wax;

petroleum waxes such as paraffin wax, microcrystalline wax, and petrolactam, and their derivatives;

hydrocarbon waxes obtained by the Fischer-Tropsch method (Fischer-Tropsch waxes), and their derivatives; and

polyolefin waxes such as polyethylene wax and polypropylene wax, and their derivatives;

higher aliphatic alcohols;

fatty acids such as stearic acid and palmitic acid;

and acid amide waxes.

The wax preferably comprises at least one selected from the group consisting of the ester waxes and aliphatic hydrocarbon waxes. If the wax includes at least one selected from the group consisting of the ester waxes and aliphatic hydrocarbon waxes, affinity for the fatty acid segments of the fatty acid metal salt (discussed below) is increased, and dispersion of the wax in the toner is improved.

More preferably, the wax in the toner comprises an ester wax, and the ester wax comprises at least one ester compound selected from the group consisting of the ester compounds of C₈₋₂₂ fatty acid monomers and alcohol monomers and the ester compounds of C₈₋₂₂ aliphatic alcohol monomers and acid monomers.

The melting point of the wax is preferably from 60.0° C. to 100.0° C., or more preferably from 65.0° C. to 90.0° C. If the melting point of the wax is at least 60.0° C., the flowability is unlikely to decline during long-term use, while if it is not more than 100.0° C. excellent low-temperature fixability can be obtained.

The content of the wax in the toner particle is preferably 0.5 mass % to 20.0 mass %.

<Fatty Acid Metal Salt>

The toner particle comprises a fatty acid metal salt. A conventionally known fatty acid metal salt may be used, but it is desirable to include a poorly water-soluble fatty acid metal salt of a divalent or higher polyvalent metal and a fatty acid.

Specific examples of the fatty acid include linear saturated fatty acids such as nonanoic acid, lauric acid, stearic acid, and behenic acid, linear unsaturated fatty acids such as oleic acid and linoleic acid, fatty acids such as 15-methylhexadecanoic acid having branched structures, and fatty acids such as 2-hydroxydodecanoic acid and 12-hydroxystearic acid having other functional groups.

The carbon number of the fatty acid is preferably from 8 to 22, or more preferably from 12 to 20. If the carbon number is at least 8, affinity with the wax is increased, further improving the dispersibility of the wax in the toner. If the carbon number is not more than 22, low-temperature fixability can be further improved.

A known metal may be used, but at least one metal selected from the group consisting of Al, Mg and Zn is preferred, and Al is more preferred. The higher the valence and the smaller the ion radius, the stronger the interactions with the oxygen atom segments in the resin A, resulting in good dispersion of the wax in the toner.

Given A mass % as the content of the wax in the toner particle and B mass % of the content of the fatty acid metal salt in the toner particle, the ratio of B to A (B/A) is preferably from 0.0010 to 1.0000 or more preferably from 0.0100 to 0.1000 from the standpoint of the flowability and fixing performance of the toner. If B/A is at least 0.0010, the dispersibility of the wax in the toner is improved, and toner flowability is further improved during long-term use. Fixing performance is further improved if B/A is not more than 1.0000.

Moreover, given B mass % of the content of the fatty acid metal salt in the toner particle and C mass % as the content of the resin A in the toner particle, the ratio of B to C (B/C) is preferably from 0.0100 to 10.0000, or more preferably from 0.1000 to 1.0000. If B/C is at least 0.0100 the dispersibility of the wax in the toner is improved, and toner flowability is further improved during long-term use. If B/C is not more than 10.0000, exudation of the fatty acid metal salt onto the toner surface is further suppressed, and flowability is further improved.

Furthermore, given E as the number of moles of silicon atoms derived from the resin A in the toner particle and F as the number of moles of the metal of the fatty acid metal salt in the toner particle, the ratio of E to F (E/F) is preferably from 0.100 to 10.000, or more preferably from 0.1000 to 6.000. It has been found that if E/F is within this range, not only is the flowability better improved long-term use but the toner charge quantity is more uniform. It is thought that this is because interactions between the fatty acid metal salt and the resin A are stronger when E/F is within this range, and the charge quantity is more uniform because the dispersibility of the fatty acid salt in the toner is improved.

The number of moles of silicon atoms derived from the resin A in the toner particle can be controlled by controlling the type and amount of the resin A when manufacturing the toner particle and the type and amount of the silane compound when manufacturing the resin A.

The number of moles of the metal of the fatty acid metal salt in the toner particle can be controlled by controlling the type and amount of the resin A when manufacturing the toner particle.

<Colorant>

The toner particle may include a colorant. The colorant is not particularly limited, and for example, the following known colorants can be used.

Examples of yellow pigment include yellow iron oxide, and condensed azo compounds such as Navels Yellow, Naphthol Yellow S, Hanza Yellow G, Hanza Yellow 10G, Benzidine Yellow G, Benzidine Yellow GR, Quinoline Yellow Lake, Permanent Yellow NCG, and Tartrazine Lake, isoindolinone compounds, anthraquinone compounds, azo metal complexes, methine compounds, and allylamide compounds. Specific examples are presented hereinbelow.

C. I. Pigment Yellow 12, 13, 14, 15, 17, 62, 74, 83, 93, 94, 95, 109, 110, 111, 128, 129, 147, 155, 168, and 180185.

Examples of orange pigments are presented below.

Permanent Orange GTR, Pyrazolone Orange, Vulcan Orange, Benzidine Orange G, Indanthrene Brilliant Orange RK, and Indanthrene Brilliant Orange GK.

Examples of red pigments include Indian Red, condensation azo compounds such as Permanent Red 4R, Lithol Red, Pyrazolone Red, Watching Red calcium salt, Lake Red C, Lake Red D, Brilliant Carmine 6B, Brilliant Carmine 3B, Eosin Lake, Rhodamine Lake B, Alizarin Lake and the like, diketopyrrolopyrrole compounds, anthraquinone compounds, quinacridone compounds, basic dye lake compounds, naphthol compounds, benzimidazolone compounds, thioindigo compounds, and perylene compounds. Specific examples are presented hereinbelow.

C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

Examples of blue pigments include copper phthalocyanine compounds and derivatives thereof such as Alkali Blue Lake, Victoria Blue Lake, Phthalocyanine Blue, metal-free Phthalocyanine Blue, partial Phthalocyanine Blue chloride, Fast Sky Blue, Indathrene Blue BG and the like, anthraquinone compounds, basic dye lake compound and the like. Specific examples are presented hereinbelow.

C. I. Pigment Blue 1, 7, 15, 15:1, 15:2, 15:3, 15:4, 60, 62, and 66.

Examples of purple pigments include Fast Violet B and Methyl Violet Lake.

Examples of green pigments include Pigment Green B, Malachite Green Lake, and Final Yellow Green G.

Examples of the white pigment include zinc white, titanium oxide, antimony white, and zinc sulfide.

Examples of black pigments include carbon black, aniline black, nonmagnetic ferrites and magnetite, and those toned to black using the abovementioned yellow colorant, red colorant and blue colorant.

These colorants may be used singly or as a mixture of a plurality thereof. These colorants can be used in the form of a solid solution.

If necessary, the colorant may be subjected to a surface treatment with a substance which does not inhibit polymerization.

The content of the colorant in the toner particle is preferably from 3.0% by mass to 15.0% by mass.

<Charge Control Agent>

The toner particle may include a charge control agent. The charge control agent is not particularly limited, and a known charge control agent can be used. In particular, a charge control agent that has a high charging speed and can stably maintain a constant charge quantity is preferable. Further, where the toner particles are produced by a direct polymerization method, a charge control agent having a low polymerization inhibition property and having substantially no matter soluble in an aqueous medium is particularly preferable.

Examples of charge control agents that control the toner particle to be negatively chargeable are presented hereinbelow.

Organometallic compounds and chelate compounds exemplified by monoazo metal compounds, acetylacetone metal compounds, and metal compounds based on aromatic hydroxycarboxylic acids, aromatic dicarboxylic acids, hydroxycarboxylic acids and dicarboxylic acids. Other examples include aromatic hydroxycarboxylic acids, aromatic mono- and polycarboxylic acids and metal salts, anhydrides, esters, phenol derivatives, such as bisphenol, thereof and the like. Furthermore, urea derivatives, metal-containing salicylic acid compounds, metal-containing naphthoic acid compounds, boron compounds, quaternary ammonium salts, and calixarenes can be mentioned.

Meanwhile, examples of charge control agents that control the toner particle to be positively chargeable are presented hereinbelow.

Nigrosine modified products such as nigrosine and fatty acid metal salts; guanidine compounds; imidazole compounds; quaternary ammonium salts such as tributylbenzylammonium-1-hydroxy-4-naphthosulfonate and tetrabutylammonium tetrafluoroborate, onium salts such as phosphonium salts, which are analogs thereof, and lake pigments thereof; triphenylmethane dyes and lake pigments thereof (examples of lake conversion agents include phosphorotungic acid, phosphomolybdic acid, phosphotungsten molybdic acid, tannic acids, lauric acid, gallic acid, ferricyanides, ferrocyanides, and the like); metal salts of higher fatty acids; and resin-based charge control agents.

These charge control agents can be used singly or in combination of a plurality thereof. The content of these charge control agents in the toner particle is preferably from 0.01% by mass to 10% by mass.

<External Additive>

The toner particle may be used as it is as a toner, but in order to improve flowability, charging performance, cleaning property, and the like, a fluidizing agent, a cleaning aid or the like, which is the so-called external additive, may be added to obtain the toner.

Examples of the external additive include inorganic oxide fine particles such as silica fine particles, alumina fine particles, titanium oxide fine particles, and the like; inorganic titanium oxide fine particles such as strontium titanate, zinc titanate, and the like; and the like. These can be used singly or in combination of a plurality thereof.

The BET specific surface area of the external additive is preferably from 10 m²/g to 450 m²/g.

The BET specific surface area is determined by a low-temperature gas adsorption method based on a dynamic constant pressure method according to a BET multipoint method. For example, the BET specific surface area (m²/g) is calculated by adsorbing nitrogen gas on the surface of a sample and performing measurement by the BET multipoint method by using a specific surface area measuring apparatus (trade name: GEMINI 2375 Ver. 5.0, manufactured by Shimadzu Corporation).

The total amount of these various external additives is preferably from 0.05 parts by mass to 10 parts by mass, and more preferably from 0.1 parts by mass to 5 parts by mass with respect to 100 parts by mass of the toner particles. Various external additives may be used in combination.

<Developer>

The toner can be used as a magnetic or nonmagnetic one-component developer, but it may be also mixed with a carrier and used as a two-component developer.

As the carrier, magnetic particles composed of conventionally known materials such as metals such as iron, ferrites, magnetite and alloys of these metals with metals such as aluminum, lead and the like can be used. Among them, ferrite particles are preferable. Further, a coated carrier obtained by coating the surface of magnetic particles with a coating agent such as a resin, a resin dispersion type carrier obtained by dispersing magnetic fine powder in a binder resin, or the like may be used as the carrier.

The volume average particle diameter of the carrier is preferably from 15 μm to 100 μm, and more preferably from 25 μm to 80 μm.

<Method for Producing Toner Particle>

Known methods can be used for producing the toner particle. Thus, a kneading pulverization method or a wet production method can be used. From the viewpoint of obtaining uniform particle diameter and shape controllability, the wet production method is preferable. The wet production methods can be exemplified by a suspension polymerization method, a dissolution suspension method, an emulsion polymerization aggregation method, an emulsion aggregation method, and the like.

This is explained below using the example of a suspension polymerization method. The suspension polymerization method may have a step of uniformly dissolving or dispersing the resin A, a polymerizable monomer for producing the binder resin, a wax, a fatty acid metal salt, and other additives such as a colorant as necessary with a disperser such as a ball mill or ultrasound disperser to prepare a polymerizable monomer composition (polymerizable monomer composition preparation step). A polyfunctional monomer, a chain transfer agent, a charge control agent, and a plasticizer and the like may also be added as necessary during this process.

The preferred examples of the polymerizable monomer in the suspension polymerization method include the following vinyl polymerizable monomers.

Styrene; styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, and the like; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, 2-benzoyloxyethyl acrylate, and the like; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, dibutyl phosphate ethyl methacrylate, and the like; methylene aliphatic monocarboxylic acid esters; vinyl esters such as vinyl acetate, vinyl propionate, vinyl benzoate, vinyl butyrate, vinyl benzoate, vinyl formate, and the like; vinyl ethers such as vinyl methyl ether, vinyl ethyl ether, vinyl isobutyl ether, and the like; vinyl methyl ketone, vinyl hexyl ketone, and vinyl isopropyl ketone.

The suspension polymerization method may include a step in which the polymerizable monomer composition is loaded into an aqueous medium prepared in advance, and a stirrer or a disperser having a high shear force is used to form droplets composed of the polymerizable monomer composition into toner particle of a desired size (granulation step).

The aqueous medium in the granulation step preferably includes a dispersion stabilizer in order to control the particle diameter of the toner particle, sharpen the particle size distribution, and prevent the coalescence of the toner particles in the production process. Dispersion stabilizers are generally classified into polymers that exhibit repulsion due to steric hindrance and poorly water-soluble inorganic compounds that stabilize dispersion by electrostatic repulsion. Fine particles of the poorly water-soluble inorganic compound are preferably used because they are dissolved by an acid or an alkali and, therefore, can be dissolved and easily removed by washing with an acid or an alkali after polymerization.

A dispersion stabilizer of the poorly water-soluble inorganic compound that includes any of magnesium, calcium, barium, zinc, aluminum and phosphorus can be preferably used. It is more preferable that any one of magnesium, calcium, aluminum and phosphorus be included. Specific examples are listed hereinbelow.

Sodium phosphate, magnesium phosphate, tricalcium phosphate, aluminum phosphate, zinc phosphate, magnesium carbonate, calcium carbonate, magnesium hydroxide, calcium hydroxide, aluminum hydroxide, calcium metasilicate, calcium sulfate, barium sulfate, calcium chloride, and hydroxyapatites.

An organic compound such as polyvinyl alcohol, gelatin, methylcellulose, methylhydroxypropylcellulose, ethylcellulose, sodium salt of carboxymethylcellulose, and starch may be used in combination with the dispersion stabilizer.

These dispersion stabilizers are preferably used in an amount from 0.01 parts by mass to 2.00 parts by mass based on 100 parts by mass of the polymerizable monomer.

Furthermore, in order to make these dispersion stabilizers finer, a surfactant may be used in combination in an amount from 0.001 part by mass to 0.1 part by mass per 100 parts by mass of the polymerizable monomer. Specifically, a commercially available nonionic surfactant, a commercially available anionic surfactant, and a commercially available cationic surfactant can be used. For example, sodium dodecyl sulfate, sodium tetradecyl sulfate, sodium pentadecyl sulfate, sodium octyl sulfate, sodium oleate, sodium laurate, potassium stearate, calcium oleate and the like are preferably used.

In the suspension polymerization method, the temperature is preferably set from 50° C. to 90° C., and the polymerizable monomers contained in the polymerizable monomer composition are polymerized to obtain a toner base particle-dispersed solution (polymerization step). The polymerization step may be performed after the granulation step, or may be performed while performing the granulation step.

In the polymerization step, it is preferable to perform a stirring operation so that the temperature distribution in the container becomes uniform. The addition of a polymerization initiator can be performed at an arbitrary timing and for a required time.

In addition, the temperature may be raised in the latter half of the polymerization reaction in order to obtain a desired molecular weight distribution, and further, in order to remove unreacted polymerizable monomers, by-products and the like from the system, a part of the aqueous medium may be distilled off by a distillation operation in the latter half of the reaction, or after completion of the reaction. The distillation operation can be performed under normal pressure or reduced pressure.

An oil-soluble initiator is generally used as the polymerization initiator to be used in the suspension polymerization method. Examples thereof are presented hereinbelow.

Azo compounds such as 2,2′-azobisisobutyronitrile, 2,2′-azobis-2,4-dimethylvaleronitrile, 1,1′-azobis(cyclohexane-1-carbonitrile), 2,2′-azobis-4-methoxy-2,4-dimethylvaleronitrile; and peroxide initiators such as acetylcyclohexylsulfonyl peroxide, diisopropyl peroxycarbonate, decanoyl peroxide, lauroyl peroxide, stearoyl peroxide, propionyl peroxide, acetyl peroxide, tert-butylperoxy-2-ethylhexanoate, benzoyl peroxide, tert-butyl peroxyisobutyrate, cyclohexanone peroxide, methyl ethyl ketone peroxide, dicumyl peroxide, tert-butyl hydroperoxide, di-tert-butyl peroxide, tert-butyl peroxypivalate, and cumene hydroperoxide.

A water-soluble initiator may be used in combination, if necessary, as the polymerization initiator, and examples thereof are listed hereinbelow.

Ammonium persulfate, potassium persulfate, 2,2′-azobis (N,N′-dimethyleneisobutyroamidine) hydrochloride, 2,2′-azobis(2-aminodinopropane) hydrochloride, azobis(isobutylamidine) hydrochloride, sodium 2,2′-azobisisobutyronitrile sulfonate, ferrous sulfate or hydrogen peroxide.

These polymerization initiators can be used singly or in combination of a plurality thereof. In order to control the degree of polymerization of the polymerizable monomers, a chain transfer agent, a polymerization inhibitor and the like can be further used in combination.

The toner particle-dispersed solution thus obtained is sent to a filtration step for solid-liquid separation of the toner particle and the aqueous medium.

Solid-liquid separation for obtaining toner particle from the obtained toner particle-dispersed solution can be performed by a general filtration method, and thereafter, washing is preferably further performed by re-slurry or washing with washing water or the like in order to remove foreign matter that could not be completely removed from the toner particle surface. After sufficient washing, solid-liquid separation is performed again to obtain a toner cake. Thereafter, the particles are dried by a known drying means, and if necessary, a particle group having a particle diameter outside a predetermined range is separated by classification to obtain toner particle. The particle group having a particle diameter outside a predetermined range that has been separated at this time may be reused in order to improve the final yield.

Regarding the particle size of the toner, from the standpoint of obtaining fine, high-resolution images the weight-average particle diameter (D4) is preferably 3.0 μm to 10.0 μm. The weight-average particle diameter (D4) of the toner is measured by the pore electrical resistance method. Specifically, it is measured with a Coulter Counter Multisizer 3 (manufactured by Beckman Coulter).

The methods for measuring the various physical property values are described below.

### <Separating Toner and External Additive>

First, where the toner particle surface has been treated with an external additive or the like, the external additive is removed by the following method to obtain the toner particle.

A total of 160 g of sucrose (manufactured by Kishida Chemical Co., Ltd.) is added to 100 mL of ion exchanged water and dissolved using a hot water bath to prepare a condensed sucrose solution. A total of 31 g of the condensed sucrose solution and 6 mL of Contaminon N (aqueous solution including 10% by mass of a neutral cleaning agent for cleaning precision measurement devices which has pH 7 and is composed of a nonionic surfactant, an anionic surfactant and an organic builder; manufactured by Wako Pure Chemical Industries, Ltd.) are added to a centrifuge tube (capacity 50 mL) to prepare a dispersion liquid. To this dispersion liquid, 1.0 g of the toner is added, and lumps of the toner are loosened with a spatula or the like.

The centrifuge tube is reciprocally shaken for 20 min at 350 spm (strokes per min) with a shaker. The solution thus shaken is transferred to a glass tube (capacity 50 mL) for swing rotors and centrifuged under conditions of 3,500 rpm for 30 min in a centrifuge (H-9R, manufactured by Kokusan Co., Ltd.). By this operation, the detached external additive is separated from the toner particle.

Thorough separation of the toner and the aqueous solution is confirmed with the naked eye, and the toner separated in the uppermost layer is collected with a spatula or the like. The collected toner is filtered with a vacuum filter and then dried for 1 hour with a drier to obtain a toner particle. These operations are performed multiple times to secure the necessary amount.

<Method for Extracting Resin A from Toner Particle>

The resin A in the toner particle is taken out by separating an extract using tetrahydrofuran (THF) by a solvent gradient elution method. The preparation method is described hereinbelow.

A total of 10.0 g of toner particles are weighed, placed in a cylindrical filter paper (No. 84, manufactured by Toyo Filter Paper Co., Ltd.), and loaded in a Soxhlet extractor. Extraction is performed for 20 h using 200 mL of THF as a solvent, and the solid matter obtained by removing the solvent from the extract is a THF-soluble matter. The resin A is contained in the THF-soluble matter. The above operations are performed a plurality of times to obtain a required amount of the THF-soluble matter.

Gradient preparative HPLC (LC-20AP high-pressure gradient preparative system manufactured by Shimadzu Corporation, SunFire preparative column 50 mmφ 250 mm manufactured by Waters Co., Ltd.) is used for the solvent gradient elution method. The column temperature is 30° C., the flow rate is 50 mL/min, acetonitrile is used as a poor solvent for the mobile phase, and THF is used as a good solvent. A solution obtained by dissolving 0.02 g of the THF-soluble matter obtained by the extraction in 1.5 mL of THF is used as a sample for separation. The mobile phase starts with a composition of 100% acetonitrile, and after 5 min from the sample injection, the ratio of THF is increased by 4% every minute, and the composition of the mobile phase is made 100% THF over 25 min. The components can be separated by drying the obtained fraction. As a result, the resin A can be obtained. Which fraction component is the resin A can be determined by measurement of the content of silicon atoms and ¹³C-NMR measurement described hereinbelow.

Solvent gradient elution may be repeated as necessary to obtain the necessary amount of the resin A.

The ratio of the mass of the resulting resin A to the mass of the toner particle used for extracting the resin A is given as the content C (mass %) of the resin A in the toner particle.

<Method for Measuring Content of Silicon Atoms in Resin A>

The content of silicon atoms in the resin A is measured using an Axios wavelength dispersive fluorescence X-ray analyzer (PANalytical). The dedicated software included with the apparatus (SuperQ ver. 4.0F, PANalytical) is used for setting the measurement conditions and analyzing the measurement data.

Rh is used for the anode of the X-ray tube, and the acceleration voltage and current value are 24 kV and 100 mA, respectively.

The measurement atmosphere is vacuum, the measurement diameter (collimator mask diameter) is 27 mm, and the measurement time is 10 seconds. A proportional counter (PC) is used as the detector. Measurement is performed by measuring the count rate (unit: cps) of Si—Kα rays observed at a diffraction angle (2θ)=109.08° using a PET spectroscopic crystal, and the content is calculated based on the calibration curve described below.

Either the resin A itself (or the resin represented by formula (1)) or the resin extracted from the toner particle by the above extraction methods is used as the measurement sample.

A BRE-32 tablet molding compressor (Maekawa Testing Machine) is used to obtain a pellet for measurement. 4 g of the measurement sample is placed in a dedicated aluminum pressing ring, spread flat, and pressed for 60 seconds at 20 MPa to a thickness of 2 mm and a diameter of 39 mm to mold a pellet.

To obtain a pellet for preparing the calibration curve for calculating content, SiO₂ (hydrophobic fumed silica, product name Aerosil NAX50, specific surface area 40±10, carbon content 0.45% to 0.85%, manufactured by Nippon Aerosil) is added in the amount of 0.50 mass parts per 100 mass parts of a binder (product name: Spectro Blend, composed of 81.0 mass % C, 2.9 mass % O, 13.5 mass % H and 2.6 mass % N, chemical formula C₁₉H₃₈ON, shape: powder (44 μm), manufactured by Rigaku), thoroughly mixed in a coffee mill, and pellet molded. Pellets are also prepared in the same way by mixing SiO₂ in the amount of 5.00 mass parts, 10.00 mass parts and 15.00 mass parts per 100 mass parts of the binder, and molding pellets.

A calibration curve of linear function is obtained by plotting the resulting X-ray count rates on the vertical axis and the added concentration of Si in each calibration curve sample on the horizontal axis.

Next, the count rate of Si—Kα rays is measured in the same way using the sample for measurement. The content of silicon atoms (mass %) is then determined from the calibration curve. The molar concentration of silicon atoms is calculated from the content of silicon atoms.

<Method for Confirming Structure of Resin A (Presence or Absence of Silyl Group Substituents and Structure of Substituents)>

The presence or absence of silyl group substituents and the structure of the substituents in the resin A is confirmed by ²⁹Si-NMR (solid) measurement and ¹³C-NMR (solid) measurement. The measurement conditions are as follows. Either the resin A itself or a resin obtained by extracting the resin from the toner particle by the above extraction methods is used for the measurement sample.

²⁹Si-NMR (Solid) Measurement Conditions

Equipment: JEOL Resonance Co. JNM-ECX500II

Sample tube: 3.2 mmϕ

Sample volume: 150 mg

Measurement temperature: Room temperature

Pulse mode: CP/MAS

Measured nuclear frequency: 97.38 MHz (²⁹Si)

Standard substance: DSS (external standard: 1.534 ppm)

Sample rotation: 10 kHz

Contact time: 10 ms

Delay time: 2 s

Cumulative number: 2,000 to 8,000 times

An abundance ratio can be determined from the above measurement by peak separation and integration in curve fitting of multiple silane components according to the number of oxygen atoms bound to silicon. The number of alkoxy groups or hydroxy groups in the resin A can be confirmed in this way.

¹³C-NMR (Solid) Measurement Conditions

Equipment: JEOL Resonance Co. JNM-ECX500II

Sample tube: 3.2 mmϕ

Sample volume: 150 mg

Measurement temperature: Room temperature

Pulse mode: CP/MAS

Measured nuclear frequency: 123.25 MHz (¹³C)

Standard substance: Adamantane (external standard: 29.5 ppm)

Sample rotation: 20 kHz

Contact time: 2 ms

Delay time: 2 s

Cumulative number: 1024 times

Based on this measurement, the peaks are separated according to the type of substituents of the silyl group in the resin A and identified to determine the structures of the individual substituents.

<Structural Confirmation of Resin A (P¹ and L¹)>

The structures of P¹ and L¹ in the resin A are confirmed by ¹³C-NMR (solid) measurement. The measurement conditions are the same as the (¹³C-NMR (solid) measurement conditions) above. Either the resin A itself or a resin obtained by extracting the resin from the toner particle by the above extraction methods is used for the measurement sample.

Based on this measurement, the peaks are separated according to the type of P¹ and L in the resin A and identified to determine the structures of P¹ and L¹.

<Method for Extracting Fatty Acid Metal Salt from Toner Particle>

10.0 g of the toner particle from which external additives have been removed is weighed, added to a cylindrical filter (No. 84 by TOYO ROSHI KAISHA, LTD.), and placed in a Soxhlet extractor. Extraction is performed for 20 hours using 200 ml of THF as the solvent, and the THF-insoluble component remaining on the cylindrical filter is dried into a solid. The resulting THF-insoluble component is then again placed in a cylindrical filter, 200 ml of chloroform is added as a solvent in the Soxhlet extractor, extraction is performed for 8 hours, and the extract is concentrated and dried to separate the fatty acid metal salt from the toner particle. These operations are repeated as necessary to obtain the necessary amount of the fatty acid metal salt.

The ratio of the mass of the resulting fatty acid metal salt to the mass of the toner particle used for extracting the fatty acid metal salt is given as the content B (mass %) of the fatty acid metal salt in the toner particle.

<Confirming Type and Measuring Molar Concentration of Metal of Fatty Acid Metal Salt in Toner Particle>

After the fatty acid metal salt has been extracted by the above methods, the molar concentration of the metal is assayed with an inductively coupled plasma atomic emission spectrophotometer (ICP-AES, manufactured by Seiko Instruments, Inc.). The type of the metal is also confirmed.

As a pre-treatment, 100.0 mg of the fatty acid metal salt is acid decomposed with 8.00 ml of 60% nitric acid (Kanto Chemical, for atomic absorption spectroscopy).

Acid decomposition treatment is performed for 1 hour in a sealed container at an internal temperature of 220° C. with an Ethos 1600 microwave high-power sample pre-treatment apparatus (Milestone Sri) to prepare a sample solution comprising a polyvalent metal element.

Ultrapure water is then added to bring the total up to 50.00 g and obtain a measurement sample. A calibration curve is prepared for each metal element, and the amount of the metal contained in the fatty acid metal salt is assayed. The type of metal contained in the fatty acid metal salt is also confirmed. The molar ratio of the metal of the fatty acid metal salt in the toner particle is obtained by comparing the resulting amount of metal to the mass of the toner particle used for extracting the fatty acid metal salt.

<Method for Measuring Weight Average Molecular Weight (Mw)>

The weight average molecular weight (Mw) of the resin is measured by gel permeation chromatography (GPC) in the following manner.

First, the sample is dissolved in tetrahydrofuran (THF) at room temperature for 24 h. Then, the obtained solution is filtered through a solvent-resistant membrane filter “Mysyori Disc” (manufactured by Tosoh Corporation) having a pore diameter of 0.2 μm to obtain a sample solution. The sample solution is prepared so that the concentration of the components soluble in THF is about 0.8% by mass. Using this sample solution, measurement is performed under the following conditions.

Device: HLC8120 GPC (detector: RI) (manufactured by Tosoh Corporation)
Column: seven columns of Shodex KF-801, 802, 803, 804, 805, 806, and 807
(manufactured by Showa Denko KK)
Eluent: tetrahydrofuran (THF)
Flow rate: 1.0 mL/min
Oven temperature: 40.0° C.
Sample injection volume: 0.10 mL

In calculating the molecular weight of the sample, a molecular weight calibration curve created using a standard polystyrene resin (trade name “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

<Method for Measuring Resin Acid Value Av>

The acid value is the number of milligrams of potassium hydroxide required to neutralize the acid contained in 1 g of the sample. The acid value of the resin is measured according to JIS K 0070-1992. Specifically, the acid value is measured according to the following procedure.

(1) Preparation of Reagent

A total of 1.0 g of phenolphthalein is dissolved in 90 mL of ethyl alcohol (95% by volume), and ion exchanged water is added to make 100 mL and obtain a phenolphthalein solution.

A total of 7 g of special grade potassium hydroxide is dissolved in 5 mL of water and ethyl alcohol (95% by volume) is added to make 1 L. The solution is placed in an alkali-resistant container and allowed to stand for 3 days so as not to be exposed to carbon dioxide gas and the like, and then filtered to obtain a potassium hydroxide solution. The obtained potassium hydroxide solution is stored in an alkali-resistant container.

A total of 25 mL of 0.1 mol/L hydrochloric acid is placed in an Erlenmeyer flask, several drops of the phenolphthalein solution are added, titration is performed with the potassium hydroxide solution, and the factor of the potassium hydroxide solution is determined from the amount of the potassium hydroxide solution required for neutralization. The 0.1 mol/L hydrochloric acid prepared according to JIS K 8001-1998 is used.

(2) Operation

(A) Main Test

A total of 2.0 g of pulverized sample is precisely weighed in a 200 ml Erlenmeyer flask, 100 ml of a mixed solution of toluene/ethanol (2:1) is added, and dissolution is performed for 5 h. Next, several drops of the phenolphthalein solution are added as an indicator, and titration is performed using the potassium hydroxide solution. The end point of the titration is when the light red color of the indicator continues for about 30 sec.

(B) Blank Test

The same titration as in the above procedure is performed except that no sample is used (that is, only a mixed solution of toluene/ethanol (2:1) is used).

(3) The Obtained Result is Substituted into the Following Equation to Calculate the Acid Value.

A=[(C−B)×f×5.61]/S

Here, A: acid value (mg KOH/g), B: addition amount (ml) of the potassium hydroxide solution in the blank test, C: addition amount (ml) of the potassium hydroxide solution in the main test, f: potassium hydroxide solution factor, and S: mass (g) of the sample.

<Method for Measuring Hydroxyl Value OHv of Resin>

The hydroxyl value is the number of milligrams of potassium hydroxide required to neutralize acetic acid bonded to a hydroxy group when acetylating 1 g of a sample. The hydroxyl value of the resin is measured according to JIS K 0070-1992.

Specifically, the hydroxyl value is measured according to the following procedure.

(1) Preparation of Reagent

A total of 25 g of special grade acetic anhydride is put into a 100 mL volumetric flask, pyridine is added to make the total volume 100 mL, and thorough shaking is performed to obtain an acetylating reagent. The obtained acetylating reagent is stored in a brown bottle to prevent exposure to moisture, carbon dioxide gas and the like.

A total of 1.0 g of phenolphthalein is dissolved in 90 mL of ethyl alcohol (95% by volume), and ion exchanged water is added to make 100 mL to obtain a phenolphthalein solution.

A total of 35 g of special grade potassium hydroxide is dissolved in 20 mL of water, and ethyl alcohol (95% by volume) is added to make 1 L. The solution is placed in an alkali-resistant container and allowed to stand for 3 days so as not to be exposed to carbon dioxide gas and the like, and then filtered to obtain a potassium hydroxide solution. The obtained potassium hydroxide solution is stored in an alkali-resistant container.

A total of 25 mL of 0.5 mol/L hydrochloric acid is placed in an Erlenmeyer flask, several drops of the phenolphthalein solution are added, titration is performed with the potassium hydroxide solution, and the factor of the potassium hydroxide solution is determined from the amount of the potassium hydroxide solution required for neutralization. The 0.5 mol/L hydrochloric acid prepared according to JIS K 8001-1998 is used.

(2) Operation

(A) Main Test

A total of 1.0 g of pulverized sample is precisely weighed in a 200 ml round bottom flask, and 5.0 mL of the acetylating reagent is accurately added thereto using a whole pipette. At this time, when the sample is difficult to dissolve in the acetylation reagent, a small amount of special grade toluene is added and dissolved.

A small funnel is placed on the mouth of the flask, the flask is immersed to about 1 cm from the bottom in a glycerin bath at about 97° C. and heated. At this time, in order to prevent the temperature of the neck of the flask from rising due to the heat of the bath, it is preferable to cover the base of the neck of the flask with cardboard having a round hole.

After 1 h, the flask is removed from the glycerin bath and allowed to cool. After cooling, 1 mL of water is added from the funnel and the flask is shaken to hydrolyze acetic anhydride. The flask is again heated in the glycerin bath for 10 min for more complete hydrolysis. After allowing to cool, the funnel and flask walls are washed with 5 mL of ethyl alcohol.

Several drops of the phenolphthalein solution as an indicator are added and titration is performed with the potassium hydroxide solution. The end point of the titration is when the light red color of the indicator continues for about 30 sec.

(B) Blank Test

The same titration as in the above procedure is performed except that no sample is used.

(3) The Obtained Result is Substituted into the Following Equation to Calculate the Hydroxyl Value.

A=[{(B−C)×28.05×f}/S]+D

Here, A: hydroxyl value (mg KOH/g), B: addition amount (mL) of the potassium hydroxide solution in the blank test, C: addition amount (mL) of the potassium hydroxide solution in the main test, f: potassium hydroxide solution factor, S: mass (g) of the sample, and D: acid value of the sample (mg KOH/g).

<Method for Extracting Wax from Toner Particle>

The wax is separated from the toner particle by Soxhlet extraction. The methods are as follows.

10.0 g of the toner particle is weighed, added to a cylindrical filter (No. 84 by TOYO ROSHI KAISHA, Ltd.), and placed in a Soxhlet extractor. This is extracted for 20 hours using 200 ml of hexane as the solvent, and the solvent is removed from the extract to obtain the wax of the toner particle.

<Method for Confirming Structure of Wax>

The wax structure is specified by nuclear magnetic resonance spectroscopy (¹H-NMR) [400 MHz, CDCl₃, room temperature (25° C.)].

Measurement equipment: JNM-EX400 FT-NMR unit (JEOL)

Measurement frequency: 400 MHz

Pulse condition: 5.0 μs

Frequency range: 10,500 Hz

Cumulative number: 64

<Method for Measuring Wax Melting Temperature>

The melting temperature of the wax is measured in accordance with ASTM D3418-82 using a Q1000 differential scanning calorimeter (TA Instruments).

The melting points of indium and zinc are used for temperature correction of the device detection part, and the fusion heat of indium is used to correct the heat quantity.

Specifically, 5 mg of sample is weighed exactly and placed in a silver pan, and using an empty silver pan for reference, a first measurement is performed as the temperature is increased from the measurement initiation temperature of 20° C. to the measurement end temperature of 180° C. at a rate of 10° C./min. The peak temperature of the maximum endothermic peak in the DSC curve in the temperature range from 20° C. to 180° C. during this first temperature rise process is determined and given as the melting point (° C.).

<Measuring Wax Content>

The content of the wax in the toner is measured in the same way using the above differential scanning calorimeter.

Specifically, the endothermic quantity of the wax alone is measured first.

1 mg of the wax extracted from the toner particle by the above methods is weighed exactly and placed in an aluminum pan, and an empty aluminum pan is used for reference. The temperature is raised from 0° C. to 150° C. at a rate of 10° C./minute and maintained at 150° C. for 5 minutes. This is then cooled to 0° C. from 150° C. at a rate of 10° C./minute and maintained at 0° C. for 5 minutes, after which the temperature is raised from 0° C. to 150° C. at a rate of 10° C./minute. The endothermic quantity ΔH1 (J/g) of the endothermic peak in the resulting DSC curve is given as the endothermic quantity of the wax alone.

The endothermic quantity of the toner particle is then measured. 1 mg of the toner particle is weighed exactly and placed in an aluminum pan, and an empty aluminum pan is used for reference. The temperature is raised from 0° C. to 150° C. at a rate of 10° C./minute, and the endothermic quantity ΔH2 (J/g) of the endothermic peak in the resulting DSC curve is given as the endothermic quantity of the toner particle.

The wax content in the toner particle is determined by the following formula from the endothermic quantity of the wax alone and the endothermic quantity of the toner particle as measured by the above methods.

Content A(mass %) of wax in toner particle=ΔH2/ΔH1×100

### EXAMPLES

Hereinafter, the present disclosure will be specifically described with reference to Examples, but the present disclosure is not limited to these Examples. All parts in Examples and Comparative Examples are based on mass unless otherwise specified.

<Manufacturing Example of Styrene-Acrylic Resin (R-1)>

A styrene-acrylic resin (R-1) was manufactured by the following procedures. 100.0 parts of propylene glycol monomethyl ether were heated under nitrogen substitution, and refluxed at a liquid temperature of at least 120° C. A mixture of 83.4 parts of styrene, 20.9 parts of n-butyl acrylate and 1.0 part of acrylic acid as polymerizable monomers and 0.6 parts of tert-butyl peroxybenzoate (organic peroxide polymerization initiator, NOF Corp., Perbutyl™ Z) as a polymerization initiator was dripped into this over the course of 3 hours.

After completion of dripping, the solution was stirred for 3 hours, and distilled at normal pressure as the liquid temperature was raised to 170° C. Once the liquid temperature had reached 170° C., the pressure was lowered to 1 hPa, and the mixture was distilled for 1 hour to remove the solvent and obtain a resin solid. The resin solid was dissolved in tetrahydrofuran and re-precipitated with n-hexane, and the precipitated solid was filtered out to obtain a styrene-acrylic resin (R-1).

The resulting styrene-acrylic resin (R-1) had an acid value of 10.6 mg KOH/g and a weight-average molecular weight (Mw) of 13,000.

<Manufacturing Example of Styrene-Acrylic Resin (R-2)>

A styrene-acrylic resin (R-2) was obtained by the same operations except that the polymerizable monomers were changed to 82.0 parts of styrene, 10.0 parts of methacrylic acid and 8.0 parts of acrylic acid, and the amount of the polymerization initiator was changed to 1.0 part in the manufacturing example of the styrene-acrylic resin (R-1).

The resulting styrene-acrylic resin (R-2) had an acid value of 161.0 mg KOH/g and a weight-average molecular weight (Mw) of 46,000.

<Manufacturing Example of Styrene-Acrylic Resin (R-3)>

A styrene-acrylic resin (R-3) was obtained by the same operations except that the polymerizable monomers were changed to 30.0 parts of methyl methacrylate and 50.4 parts of acrylic acid, and the amount of the polymerization initiator was changed to 1.0 part in the manufacturing example of the styrene-acrylic resin (R-1).

The resulting styrene-acrylic resin (R-3) had an acid value of 351.0 mg KOH/g and a weight-average molecular weight (Mw) of 8,700.

<Manufacturing Example of Styrene-Acrylic Resin (R-4)>

A polyester resin (R-4) was manufactured by the following procedures.

The following materials were loaded into an autoclave equipped with a decompressor, a moisture separator, a nitrogen gas introduction device, a temperature measurement device, and a stirring device, and reacted for 5 hours at 200° C., normal pressure in a nitrogen atmosphere.

| | | |
|---|---|---|
| Bisphenol A propylene oxide 2.1-mol adduct | 39.6 | parts |
| Terephthalic acid | 8.0 | parts |
| Isophthalic acid | 7.6 | parts |
| Tetrabutoxy titanate | 0.1 | parts |

0.01 parts of trimellitic acid and 0.12 parts of tetrabutoxy titanate were then added, and the mixture was reacted for 3 hours at 220° C. and then reacted for 2 hours under reduced pressure of 10 mmHg to 20 mmHg to obtain a polyester resin (R-4).

The resulting polyester resin (R-4) had an acid value of 6.1 mg KOH/g and a weight-average molecular weight (Mw) of 10,200.

<Synthesizing Polyester Resin (R-5)>

Poly ε-caprolactone having a stearyl ester at the carboxylic acid end (polyester resin (R-5)) was synthesized by the following procedures.

The following materials were loaded into a reactor equipped with a nitrogen gas introduction device, a temperature measurement device, and a stirring device, and reacted for 5 hours at 100° C. in a nitrogen atmosphere.

| | | |
|---|---|---|
| Stearyl alcohol | 3.0 | parts |
| ε-caprolactone | 38.2 | parts |
| Titanium (IV) tetraisopropoxide | 0.5 | parts |

The resulting resin was dissolved in chloroform, and this solution was dripped into methanol, re-precipitated, and filtered to obtain a polyester resin (R-5).

The resulting polyester resin (R-5) had an acid value of 0.0 mg KOH/g, a hydroxyl group value of 30.3 mg KOH/g, and a Mw of 8,300.

<Synthesizing Polyester Resin (R-6)>

A polylactic acid (polyester resin (R-6)) was synthesized by the following procedures.

The following materials were loaded into an autoclave equipped with a decompressor, a moisture separator, a nitrogen gas introduction device, a temperature measurement device, and a stirring device, and reacted for 5 hours at 200° C., normal pressure in a nitrogen atmosphere.

| | | |
|---|---|---|
| Lactic acid | 100.0 | parts |
| Tetrabutoxy titanate | 0.1 | parts |

An additional 0.1 parts of tetrabutoxy titanate were added, and the mixture was reacted at 220° C. for 3 hours and then further reacted for 2 hours under reduced pressure of 10 mmHg to 20 mmHg. The resulting resin was dissolved in chloroform, and this solution was dripped into ethanol, re-precipitated, and filtered to obtain a polyester resin (R-6).

The resulting polyester resin (R-6) had an acid value of 3.5 mg KOH/g and a Mw of 30,000.

<Manufacturing Examples of Resin A>

<Manufacturing Example of Resin (A-1)>

A resin (A-1) represented by formula (1) was manufactured by the following procedures. 50.00 parts of the styrene-acrylic resin (R-1) were dissolved as P¹ (polymer segment) in 200.00 parts of N,N-dimethylacetamide, 1.20 parts of 3-aminopropyl triethoxysilane as a silane compound, 2.87 parts of triethylamine, and 2.88 parts of DMT-MM (4-(4-6-dimethoxy-1,3,5-triazine-2-yl)-4-methylmorpholinium chloride) as a condensing agent were added, and the mixture was stirred for 5 hours at normal temperature. After completion of the reaction, this solution was dripped into methanol, re-precipitated, and filtered to obtain a resin (A-1) having a weight-average molecular weight Mw of 13,200.

<Manufacturing Examples of Resins (A-2) to (A-5) and Resins (A-9) to (A-17)>

Resins (A-2) to (A-5) and resins (A-9) to (A-17) were obtained as in the manufacturing example of the resin (A-1) except that the type of P¹ (polymer segment), the type and added amount of the silane compound, and the added amounts of triethylamine and DMT-MM were changed as shown in Table 1.

<Manufacturing Example of Resin (A-6)>

A solution of 10.0 parts of the resin (A-5) dissolved in 90.0 parts of toluene was mixed and stirred with 400.0 parts of pure water, the pH was adjusted to 4.0 with dilute hydrochloric acid, and this was stirred for 10.8 hours at normal temperature, after which stirring was stopped and the mixture was transferred to a separation funnel to extract the oil phase. The oil phase was concentrated and re-precipitated with methanol to obtain a resin (A-6) represented by formula (1).

When the resin (A-6) was analyzed by ²⁹Si-NMR (solid) measurement, R¹ to R³ in formula (1) were all found to be hydroxy groups.

<Manufacturing Example of Resin (A-7)>

A resin (A-7) was manufactured by the following procedures.

50.00 parts of the polyester resin (R-4) were dissolved in 500.00 parts of chloroform, 0.74 parts of 3-isocyanatopropyl triethoxysilane, 1.65 parts of triethylamine and 0.50 parts of titanium (IV) tetraisopropoxide were added in a nitrogen atmosphere, and the mixture was stirred for 5 hours at normal temperature. After completion of the reaction, the solution was dripped into methanol, re-precipitated, and filtered to obtain a resin (A-7).

<Manufacturing Example of Resin (A-8)>

A resin (A-8) was synthesized as in the manufacturing example of the resin (A-7) except that the polyester resin (R-5) was substituted for the polyester resin (R-4), and the added amount of the 3-isocyanatopropyl triethoxysilane was changed from 0.74 parts to 6.61 parts.

<Manufacturing Example of Resin (A-18)>

| | | |
|---|---|---|
| Diphenylmethane diisocyanate (MDI) | 41.3 | parts |
| Bisphenol A ethylene oxide 2-mol adduct (BPA-2EO) | 33.8 | parts |
| Tetrahydrofuran (THF) | 300.0 | parts |

These materials were loaded under nitrogen substitution into a reactor equipped with a stirrer and a thermometer. This was heated to 50° C. and a urethane reaction was performed for 8 hours, after which 1.0 part of 3-isocyanatopropyl triethoxysilane was added and the mixture was reacted for a further 8 hours. 3.0 parts of t-butyl alcohol were then added to modify the isocyanate termini. The THF solvent was distilled off to obtain a resin (A-18). The resin (A-18) had a weight-average molecular weight Mw of 23,500.

TABLE 1

| | | | | | | | Condensing |
|---|---|---|---|---|---|---|---|
| | | | | | | | agent |
| | P¹ | | | Silane compound | | Triethylamine | (DMT-MM) |
| | polymer segment | | | | Added | Added | Added |
| Resin A | | | Acid value | | amount | amount | amount |
| Type | Type | Mw | (mg KOH/g) | Type | (pts) | (pts) | (pts) |
| A-1 | R-1 | 13000 | 10.6 | 3-aminopropyl triethoxysilane | 1.20 | 2.87 | 2.88 |
| A-2 | R-1 | 13000 | 10.6 | 3-aminopropyl dimethylethoxysilane | 0.85 | 2.87 | 2.88 |
| A-3 | R-1 | 13000 | 10.6 | 3-aminopropyl trimethylsilane | 0.70 | 2.87 | 2.88 |
| A-4 | R-2 | 46000 | 161.0 | 3-aminopropyl silane | 10.00 | 43.55 | 43.67 |
| A-5 | R-1 | 13000 | 10.6 | 3-aminopropyl trimethoxysilane | 0.95 | 2.87 | 2.88 |
| A-6 | Described in Description | | | | | | |
| A-7 | R-4 | 10200 | 6.1 | 3-isocyanatopropyl triethoxysilane | 0.74 | 1.65 | — |
| A-8 | R-5 | 8300 | 0.0 | 3-isocyanatopropyl triethoxysilane | 6.61 | 1.65 | — |
| A-9 | R-6 | 30000 | 3.5 | 3-aminopropyl triethoxysilane | 0.69 | 1.65 | 2.88 |
| A-10 | R-1 | 13000 | 10.6 | 3-aminopropyl triethoxysilane | 0.05 | 2.87 | 2.88 |
| A-11 | R-1 | 13000 | 10.6 | 3-aminopropyl triethoxysilane | 0.10 | 2.87 | 2.88 |
| A-12 | R-1 | 13000 | 10.6 | 3-aminopropyl triethoxysilane | 0.70 | 2.87 | 2.88 |
| A-13 | R-1 | 13000 | 10.6 | 3-aminopropyl triethoxysilane | 8.50 | 12.23 | 12.26 |
| A-14 | R-3 | 8700 | 351.0 | 3-aminopropyl triethoxysilane | 18.00 | 94.95 | 95.21 |
| A-15 | R-3 | 8700 | 351.0 | 3-aminopropyl triethoxysilane | 40.50 | 94.95 | 95.21 |
| A-16 | R-3 | 8700 | 351.0 | 3-aminopropyl triethoxysilane | 69.20 | 94.95 | 95.21 |
| A-17 | R-4 | 10200 | 6.1 | 3-aminopropyl triethoxysilane | 1.20 | 1.65 | 1.65 |

| | |
|---|---|
| A-18 | Described in Description |

pts: parts

The physical properties of the resulting resins (A-1) to (A-18) are shown in Table 2.

TABLE 2

| | | | | | | | | | Silicon |
|---|---|---|---|---|---|---|---|---|---|
| | | | | | | | | | concentration |
| Resin A | P¹ | R¹ | R² | R³ | L¹ | R⁵ | R⁶ | Mw | (mass %) |
| A-1 | R-1 | —OC₂H₅ | —OC₂H₅ | —OC₂H₅ | formula(2) | —C₃H₆— | — | 13200 | 0.22 |
| A-2 | R-1 | —OC₂H₅ | —CH₃ | —CH₃ | formula(2) | —C₃H₆— | — | 13200 | 0.22 |
| A-3 | R-1 | —CH₃ | —CH₃ | —CH₃ | formula(2) | —C₃H₆— | — | 13200 | 0.22 |
| A-4 | R-2 | —H | —H | —H | formula(2) | —C₃H₆— | — | 46000 | 4.02 |
| A-5 | R-1 | —OCH₃ | —OCH₃ | —OCH₃ | formula(2) | —C₃H₆— | — | 13200 | 0.22 |
| A-6 | R-1 | —OH | —OH | —OH | formula(2) | —C₃H₆— | — | 13100 | 0.22 |
| A-7 | R-4 | —OC₂H₅ | —OC₂H₅ | —OC₂H₅ | formula(3) | — | —C₃H₆— | 10400 | 0.22 |
| A-8 | R-5 | —OC₂H₅ | —OC₂H₅ | —OC₂H₅ | formula(3) | — | —C₃H₆— | 8300 | 0.97 |
| A-9 | R-6 | —OC₂H₅ | —OC₂H₅ | —OC₂H₅ | formula(2) | —C₃H₆— | — | 30500 | 0.20 |
| A-10 | R-1 | —OC₂H₅ | —OC₂H₅ | —OC₂H₅ | formula(2) | —C₃H₆— | — | 13000 | 0.01 |
| A-11 | R-1 | —OC₂H₅ | —OC₂H₅ | —OC₂H₅ | formula(2) | —C₃H₆— | — | 13000 | 0.02 |
| A-12 | R-1 | —OC₂H₅ | —OC₂H₅ | —OC₂H₅ | formula(2) | —C₃H₆— | — | 13200 | 0.13 |
| A-13 | R-1 | —OC₂H₅ | —OC₂H₅ | —OC₂H₅ | formula(2) | —C₃H₆— | — | 13300 | 1.36 |
| A-14 | R-3 | —OC₂H₅ | —OC₂H₅ | —OC₂H₅ | formula(2) | —C₃H₆— | — | 21500 | 4.92 |
| A-15 | R-3 | —OC₂H₅ | —OC₂H₅ | —OC₂H₅ | formula(2) | —C₃H₆— | — | 21900 | 8.33 |
| A-16 | R-3 | —OC₂H₅ | —OC₂H₅ | —OC₂H₅ | formula(2) | —C₃H₆— | — | 22100 | 10.80 |
| A-17 | R-4 | —OC₂H₅ | —OC₂H₅ | —OC₂H₅ | formula(2) | —C₃H₆— | — | 10400 | 0.22 |
| A-18 | Polyurethane | —OC₂H₅ | —OC₂H₅ | —OC₂H₅ | formula(3) | — | —C₃H₆— | 23500 | 0.32 |

<Manufacturing Example of Toner Particle 1>

390.0 parts of deionized water and 14.0 parts of sodium phosphate (12-hydrate) (manufactured by Rasa Industries) were loaded into a reactor and kept warm for 1.0 hour at 65° C. under nitrogen purging. This was then stirred at 12,000 rpm with a T.K. Homomixer (Tokushu Kika) as an aqueous calcium chloride solution of 9.2 parts of calcium chloride (dihydrate) dissolved in 10.0 parts of deionized water was added all at once to prepare an aqueous medium comprising a dispersion stabilizer. Hydrochloric acid was then added to adjust the pH of the aqueous medium to 6.0 and obtain an aqueous medium 1.

Meanwhile, the following materials were placed in an attritor (Nippon Coke & Engineering), zirconia particles 1.7 mm in diameter were added, and the mixture was dispersed for 5.0 hours at 220 rpm, after which the zirconia particles were removed to prepare a dispersion 1 of a dispersed colorant.

| | | |
|---|---|---|
| Styrene | 60.0 | parts |
| Colorant (C.I. pigment blue 15:3) | 6.5 | parts |

The following materials were then added to the prepared dispersion 1.

| | | |
|---|---|---|
| Styrene | 15.0 | parts |
| N-butyl acrylate | 25.0 | parts |
| Polyester resin (R-4) | 4.0 | parts |
| Resin A (A-1) | 0.5 | parts |
| Aluminum distearate | 0.2 | parts |
| Divinyl benzene | 0.3 | parts |
| Wax (ethylene glycol distearate: melting point 76° C.) | 12.0 | parts |

This was kept at 65° C. and uniformly dissolved and dispersed at 500 rpm with a T.K. Homomixer to prepare a polymerizable monomer composition 1.

The temperature of the above aqueous medium 1 was kept at 70° C. and the rotation of the stirrer at 12,000 rpm as the polymerizable monomer composition 1 was added to the aqueous medium 1, and 9.0 parts of t-butyl peroxypivalate were added as a polymerization initiator. This was then granulated as is or 10 minutes in the same stirring apparatus with the rotation maintained at 12,000 rpm.

The stirring apparatus was replaced with a stirrer having a propeller blade, and the mixture was polymerized for 5.0 hours at 150 rpm with the temperature maintained at 70° C. The temperature was raised to 85° C., and heating was maintained for 2.0 hours, after which the mixture was cooled to room temperature to obtain a toner particle dispersion 1.

Hydrochloric acid was added to adjust the pH of the toner particle dispersion 1 to 1.4 and dissolve the dispersion stabilizer, and the mixture was filtered, washed, and dried to obtain a toner particle 1.

<Manufacturing Examples of Toner Particles 2 to 37 and 42 to 44>

Toner particles 2 to 37 and 42 to 44 were manufactured as in the manufacturing example of the toner particle 1 except that the materials added to the dispersion 1 were changed as shown in Table 3.

TABLE 3

| | Materials added to dispersion | | | | | | | | | | | | |
|---|---|---|---|---|---|---|---|---|---|---|---|---|---|
| | | N-butyl | Polyester | | | | Fatty acid metal | | Divinyl | | | | |
| Toner | Styrene | acrylate | resin | | Resin A | | salt | | benzene | Wax | | | |
| particle | Parts | Parts | Type | Parts | Type | Parts | Type | Parts | Parts | Type | Parts | Type | Parts |
| 1 | 15.0 | 25.0 | R-4 | 4.0 | A-1 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 2 | 15.0 | 25.0 | R-4 | 4.0 | A-17 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 3 | 15.0 | 25.0 | R-4 | 4.0 | A-1 | 0.5 | Zn | 0.2 | 0.3 | Ethylene glycol | 12.0 | | |
| | | | | | | | distearate | | | distearate (melting | | | |
| | | | | | | | | | | point 76° C.) | | | |
| 4 | 15.0 | 25.0 | R-4 | 4.0 | A-1 | 0.5 | Mg | 0.2 | 0.3 | Ethylene glycol | 12.0 | | |
| | | | | | | | distearate | | | distearate (melting | | | |
| | | | | | | | | | | point 76° C.) | | | |
| 5 | 15.0 | 25.0 | R-4 | 4.0 | A-1 | 0.5 | Ca | 0.2 | 0.3 | Ethylene glycol | 12.0 | | |
| | | | | | | | distearate | | | distearate (melting | | | |
| | | | | | | | | | | point 76° C.) | | | |
| 6 | 15.0 | 25.0 | R-4 | 4.0 | A-1 | 0.5 | Al | 0.2 | 0.3 | Ethylene glycol | 12.0 | | |
| | | | | | | | dibehenate | | | distearate (melting | | | |
| | | | | | | | | | | point 76° C.) | | | |
| 7 | 15.0 | 25.0 | R-4 | 4.0 | A-1 | 1 | Al | 0.2 | 0.3 | Ethylene glycol | 12.0 | | |
| | | | | | | | dimontanate | | | distearate (melting | | | |
| | | | | | | | | | | point 76° C.) | | | |
| 8 | 15.0 | 25.0 | R-4 | 4.0 | A-1 | 1 | Al | 0.2 | 0.3 | Ethylene glycol | 12.0 | | |
| | | | | | | | dioctanoate | | | distearate (melting | | | |
| | | | | | | | | | | point 76° C.) | | | |
| 9 | 15.0 | 25.0 | R-4 | 4.0 | A-1 | 1 | Al | 0.2 | 0.3 | Ethylene glycol | 12.0 | | |
| | | | | | | | dihexanoate | | | distearate (melting | | | |
| | | | | | | | | | | point 76° C.) | | | |
| 10 | 15.0 | 25.0 | R-4 | 4.0 | A-2 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 11 | 15.0 | 25.0 | R-4 | 4.0 | A-3 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 12 | 15.0 | 25.0 | R-4 | 4.0 | A-4 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 13 | 15.0 | 25.0 | R-4 | 4.0 | A-5 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 14 | 15.0 | 25.0 | R-4 | 4.0 | A-6 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 15 | 15.0 | 25.0 | R-4 | 4.0 | A-7 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 16 | 15.0 | 25.0 | R-4 | 4.0 | A-8 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 17 | 15.0 | 25.0 | R-4 | 4.0 | A-9 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 18 | 15.0 | 25.0 | R-4 | 4.0 | A-1 | 0.5 | Al | 0.2 | 0.3 | Ethylene glycol | 12.0 | Fischer-Tropsch | 5.0 |
| | | | | | | | distearate | | | distearate (melting | | wax (melting | |
| | | | | | | | | | | point 76° C.) | | point 78° C.) | |
| 19 | 15.0 | 25.0 | R-4 | 4.0 | A-1 | 0.5 | Al | 0.2 | 0.3 | Fischer-Tropsch | 12.0 | | |
| | | | | | | | distearate | | | wax (melting | | | |
| | | | | | | | | | | point 78° C.) | | | |
| 20 | 15.0 | 25.0 | R-4 | 4.0 | A-1 | 0.5 | Al | 0.2 | 0.3 | Octanediol | 12.0 | | |
| | | | | | | | distearate | | | distearate (melting | | | |
| | | | | | | | | | | point 57° C.) | | | |
| 21 | 15.0 | 25.0 | R-4 | 4.0 | A-1 | 0.5 | Al | 0.2 | 0.3 | Ethylene glycol | 12.0 | | |
| | | | | | | | distearate | | | dimyristate (melting | | | |
| | | | | | | | | | | point 63° C.) | | | |
| 22 | 15.0 | 25.0 | R-4 | 4.0 | A-1 | 0.5 | Al | 0.2 | 0.3 | Ethylene glycol | 12.0 | | |
| | | | | | | | distearate | | | dimontanate (melting | | | |
| | | | | | | | | | | point 95° C.) | | | |

| | Materials added to dispersion | | | | | | | | | | | | |
|---|---|---|---|---|---|---|---|---|---|---|---|---|---|
| | | N-butyl | Polyester | | | | Fatty acid metal | | Divinyl | | | | |
| Toner | Styrene | acrylate | resin | | Resin A | | salt | | benzene | Wax | | | |
| particle | Parts | Parts | Type | Parts | Type | Parts | Type | Parts | Parts | Type | Parts | Type | Parts |
| 23 | 15.0 | 25.0 | R-4 | 4.0 | A-10 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 24 | 15.0 | 25.0 | R-4 | 4.0 | A-11 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 25 | 15.0 | 25.0 | R-4 | 4.0 | A-12 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 26 | 15.0 | 25.0 | R-4 | 4.0 | A-14 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 27 | 15.0 | 25.0 | R-4 | 4.0 | A-15 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 28 | 15.0 | 25.0 | R-4 | 4.0 | A-16 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 29 | 15.0 | 25.0 | R-4 | 4.0 | A-1 | 0.5 | Al | 0.01 | 0.3 | Ethylene glycol | 12.0 | | |
| | | | | | | | distearate | | | distearate (melting | | | |
| | | | | | | | | | | point 76° C.) | | | |
| 30 | 15.0 | 25.0 | R-4 | 4.0 | A-1 | 2 | Al | 1 | 0.3 | Ethylene glycol | 9.0 | | |
| | | | | | | | tristearate | | | distearate (melting | | | |
| | | | | | | | | | | point 76° C.) | | | |
| 31 | 15.0 | 25.0 | R-4 | 4.0 | A-1 | 8 | Al | 0.06 | 0.3 | Ethylene glycol | 12.0 | | |
| | | | | | | | distearate | | | distearate (melting | | | |
| | | | | | | | | | | point 76° C.) | | | |
| 32 | 15.0 | 25.0 | R-4 | 4.0 | A-15 | 0.08 | Al | 1 | 0.3 | Ethylene glycol | 12.0 | | |
| | | | | | | | tristearate | | | distearate (melting | | | |
| | | | | | | | | | | point 76° C.) | | | |
| 33 | 15.0 | 25.0 | R-4 | 4.0 | A-1 | 0.5 | Al | 1 | 0.3 | Ethylene glycol | 12.0 | | |
| | | | | | | | distearate | | | distearate (melting | | | |
| | | | | | | | | | | point 76° C.) | | | |
| 34 | 15.0 | 25.0 | R-4 | 4.0 | A-13 | 4 | Al | 0.06 | 0.3 | Ethylene glycol | 12.0 | | |
| | | | | | | | distearate | | | distearate (melting | | | |
| | | | | | | | | | | point 76° C.) | | | |
| 35 | 15.0 | 25.0 | R-4 | 4.0 | A-1 | 0.5 | Al | 0.5 | 0.3 | Ethylene glycol | 12.0 | | |
| | | | | | | | distearate | | | distearate (melting | | | |
| | | | | | | | | | | point 76° C.) | | | |
| 36 | 15.0 | 25.0 | R-4 | 4.0 | A-1 | 6 | Al | 0.1 | 0.3 | Ethylene glycol | 12.0 | | |
| | | | | | | | distearate | | | distearate (melting | | | |
| | | | | | | | | | | point 76° C.) | | | |
| 37 | 15.0 | 25.0 | R-4 | 4.0 | A-18 | 0.5 | Al | 0.2 | 0.3 | Ethylene glycol | 12.0 | | |
| | | | | | | | distearate | | | distearate (melting | | | |
| | | | | | | | | | | point 76° C.) | | | |
| 42 | 15.0 | 25.0 | R-4 | 4.0 | A-1 | 0.2 | — | — | 0.3 | Ethylene glycol | 12.0 | | |
| | | | | | | | | | | distearate (melting | | | |
| | | | | | | | | | | point 76° C.) | | | |
| 43 | 15.0 | 25.0 | R-4 | 4.0 | — | — | Al | 0.2 | 0.3 | Ethylene glycol | 12.0 | | |
| | | | | | | | distearate | | | distearate (melting | | | |
| | | | | | | | | | | point 76° C.) | | | |
| 44 | 15.0 | 25.0 | R-4 | 4.0 | — | — | — | — | 0.3 | Ethylene glycol | 12.0 | | |
| | | | | | | | | | | distearate (melting | | | |
| | | | | | | | | | | point 76° C.) | | | |

<Manufacturing Example of Toner Particle 38>

660.0 pars of deionized water were mixed with 25.0 parts of a 48.5% aqueous solution of dodecyl diphenyl ether sodium disulfonate and stirred at 10,000 rpm with a T.K. Homomixer to prepare an aqueous medium 2.

The following materials were added to 500.0 parts of ethyl acetate and dissolved at 100 rpm with a propeller stirring apparatus to prepare a solution.

| | | |
|---|---|---|
| Styrene/butyl acrylate copolymer | 100.0 | parts |
| (copolymerization ratio 80/20) | | |
| Resin A (A-1) | 0.5 | parts |
| Aluminum distearate | 0.2 | parts |
| Polyester resin (R-4) | 4.0 | parts |
| Colorant (C.I. pigment blue 15:3) | 6.5 | parts |
| Wax (ethylene glycol distearate: melting point 76° C.) | 12.0 | parts |

150.0 parts of the aqueous medium 2 were placed in a container and stirred at 12,000 rpm with a T.K. Homomixer, and 100.0 parts of the above solution were added thereto and mixed for 10 minutes to prepare an emulsified slurry.

100.0 parts of the emulsified slurry were loaded into a flask equipped with a degassing pipe, a stirrer, and a thermometer, stirred at 500 rpm as the solvent was removed under reduced pressure for 12 hours at 30° C., and cured for 4 hours at 45° C. to obtain a solvent-free slurry.

The solvent-free slurry was vacuum filtered, and 300.0 parts of deionized water were added to the resulting filter cake, which was then redispersed by mixing with a T.K. Homomixer (10 minutes at 12,000 rpm) and filtered.

The resulting filter cake was dried for 48 hours at 45° C. in a drier and sieved with a 75 μm mesh to obtain a toner particle 38.

<Manufacturing Example of Toner Particle 39>

### Manufacturing Dispersion of Binder Resin Fine Particle

60 parts of ethylene vinyl acetate resin (Tosoh: Ultrasen 685), 0.5 parts of the resin A (A-1) and 0.2 parts of aluminum distearate were added to 200 parts of toluene (Wako Pure Chemical), heated to 90° C., and dissolved by stirring for 3 hours.

6 parts of an anionic surfactant (Daiichi Kogyo: Neogen RK) and 3 parts of another anionic surfactant (NOF: Nonsoul LN1) dissolved in 180 parts of deionized water were added to the toluene solution of the ethylene vinyl acetate resin, Resin A and aluminum distearate. This was then thoroughly stirred at 4,000 rpm with a T.K. Robomix high-speed stirring apparatus (manufactured by Primix). This was then dispersed for about 1 hour with a Nanomizer high-pressure impact disperser (manufactured by Yoshida Kikai), after which the toluene was removed with an evaporator and the solids concentration was adjusted to 28% with deionized water to obtain a dispersion of a binder resin fine particle.

### Manufacturing Dispersion of Wax Fine Particle

| | | |
|---|---|---|
| Wax (ethylene glycol distearate: melting point 76° C.) | 20.0 | parts |
| Anionic surfactant (DKS Co. Ltd.: Neogen RK) | 1.0 | parts |
| Deionized water | 79.0 | parts |

This formulation was placed in a mixing vessel equipped with a stirring device, heated to 90° C., circulated to a Clearmix W-Motion (M-Technique) while being stirred and dispersion treated for 60 minutes at a rotor speed of 19,000 rpm and a screen rotation of 19,000 rpm in a shear agitation site with an external rotor diameter of 3 cm and a clearance of 0.3 mm, and then cooled to 40° C. under cooling conditions of rotor speed 1,000 rpm, screen rotation 0 rpm, cooling rate 10° C./min, and the solids concentration was adjusted to 20% with deionized water to obtain a wax fine particle dispersion.

### Manufacturing Pigment Dispersion

| | | |
|---|---|---|
| C.I. pigment blue 15:3 | 10.0 | parts |
| Deionized water | 78.0 | parts |
| Anionic surfactant (DKS Co. Ltd.: Neogen RK) | 2.0 | parts |

These materials were mixed and then dispersed for 1 hour with a Nanomizer high-pressure impact disperser (manufactured by Yoshida Kikai), and the solids concentration was adjusted to 10% with deionized water to prepare a pigment dispersion.

### Manufacturing Toner Particle

| | | |
|---|---|---|
| Binder resin fine particle dispersion (solids 28%) | 320.0 | parts |
| Pigment dispersion (solids 10%) | 50.0 | parts |
| Wax fine particle dispersion (solids 20%) | 75.0 | parts |

These materials were placed in a round stainless-steel flask, and mixed. An aqueous solution of 8 parts of magnesium sulfate dissolved in 98.0 parts of deionized water was then added, and the mixture was dispersed for 10 minutes at 5,000 rpm with a Homogenizer (IKA Ultra-Turrax T50). This was then heated to 50° C. in a heating water bath using a stirring blade with the rotation adjusted appropriately so as to stir the mixture. This was maintained for 1 hour at 50° C., and the weight-average particle diameter (D4) of the formed aggregate particles was measured. It was thus confirmed that aggregate particles with a weight-average particle diameter (D4) of about 6.0 μm had formed.

An aqueous solution of 40 parts of ethylene diamine sodium tetraacetate dissolved in 360 parts of deionized water was added to the resulting dispersion of aggregate particles, and a further 2,800 parts of deionized water were added. The mixture was heated to 80° C. under continued stirring and then maintained in a sealed state for 2 hours to obtain thoroughly fused particles. Following filtration and solid-liquid separation, the filtrate was thoroughly washed with deionized water and dried with a vacuum drier to obtain a toner particle 39 with a weight-average particle diameter (D4) of 6.7 μm.

<Manufacturing Example of Toner Particle 40>

### Manufacturing Polyester Resin (R-7)

The following materials were placed in a reaction tank equipped with a nitrogen introduction pipe, a dewatering pipe, a stirrer, and a thermocouple, and stirred and mixed to prepare a monomer solution.

| | | |
|---|---|---|
| Terephthalic acid | 65.0 | parts |
| Bisphenol A propylene oxide 2-mol adduct | 100.0 | parts |

Dibutyl tin as a catalyst was added to this monomer solution in the amount of 1.5 parts per 100 parts of the total monomers. The temperature was then raised rapidly to 180° C. at normal pressure in a nitrogen atmosphere, and then raised from 180° C. to 210° C. at a rate of 10° C./hour as the water was distilled off to perform polycondensation. Once 210° C. was reached the reaction tank was depressurized to not more than 5 kPa, and polycondensation was performed under conditions of 210° C., 5 kPa to obtain a polyester resin (R-7).

During this process, the polymerization time was adjusted so that the resulting polyester resin (R-7) had a softening point of 115° C.

### Manufacturing Toner Particle

| | | |
|---|---|---|
| Polyester resin (R-7) | 90.0 | parts |
| Polyester resin (R-4) | 10.0 | parts |
| C.I. pigment blue (15:3) | 6.5 | parts |
| Resin A (A-1) | 0.5 | parts |
| Aluminum distearate | 0.2 | parts |
| Wax (ethylene glycol distearate: melting point 76° C.) | 12.0 | parts |

These materials were mixed in a Henschel Mixer (FM-75, Mitsui Miike) and kneaded in a 2-axis extruder (Ikegai Corp. PCM-30) at a rotation of 3.3 s⁻¹ and a kneading temperature of 120° C. The kneaded product was cooled and crushed to 1 mm or less in a hammer mill to obtain a crushed product. The crushed product was then finely pulverized in a mechanical pulverizer (Turbo Industries T-250). The resulting fine powder was classified with a multi-division classifier using the Coanda effect to obtain a toner particle 40 with a weight-average particle diameter (D4) of 7.5 μm.

<Manufacturing Example of Toner Particle 41>

A toner particle 41 was obtained as in the manufacturing example of the toner particle 40 except that the resin A (A-17) was substituted for the resin A (A-1).

<Manufacturing Examples of Toners 1 to 44>

Using a Henschel mixer (Mitsui Miike), 0.6 parts of a hydrophobic silica particle with a BET value of 200 m²/g and a number-average particle size of 8 nm of the primary particles were mixed with 100.0 parts of each of the toner particles 1 to 44, and these were each sieved with a 150 μm mesh to obtain toners 1 to 44.

The physical properties of the resulting toners 1 to 44 are shown in Table 4.

TABLE 4

| | Toner | Toner | | | | | |
|---|---|---|---|---|---|---|---|
| Toner | particle | D4(mm) | Binder resin | P¹ | B/A | B/C | E/F |
| 1 | 1 | 7.1 | Styrene-acrylic | Styrene-acrylic | 0.0167 | 0.4000 | 0.120 |
| 2 | 2 | 6.9 | Styrene-acrylic | Polyester | 0.0167 | 0.4000 | 0.120 |
| 3 | 3 | 7.3 | Styrene-acrylic | Styrene-acrylic | 0.0167 | 0.4000 | 0.124 |
| 4 | 4 | 6.7 | Styrene-acrylic | Styrene-acrylic | 0.0167 | 0.4000 | 0.116 |
| 5 | 5 | 7.5 | Styrene-acrylic | Styrene-acrylic | 0.0167 | 0.4000 | 0.119 |
| 6 | 6 | 7.2 | Styrene-acrylic | Styrene-acrylic | 0.0167 | 0.4000 | 0.141 |
| 7 | 7 | 7.3 | Styrene-acrylic | Styrene-acrylic | 0.0167 | 0.2000 | 0.174 |
| 8 | 8 | 7.0 | Styrene-acrylic | Styrene-acrylic | 0.0167 | 0.2000 | 0.129 |
| 9 | 9 | 7.0 | Styrene-acrylic | Styrene-acrylic | 0.0167 | 0.2000 | 0.107 |
| 10 | 10 | 6.8 | Styrene-acrylic | Styrene-acrylic | 0.0167 | 0.4000 | 0.120 |
| 11 | 11 | 6.9 | Styrene-acrylic | Styrene-acrylic | 0.0167 | 0.4000 | 0.120 |
| 12 | 12 | 7.3 | Styrene-acrylic | Styrene-acrylic | 0.0167 | 0.4000 | 2.185 |
| 13 | 13 | 7.0 | Styrene-acrylic | Styrene-acrylic | 0.0167 | 0.4000 | 0.120 |
| 14 | 14 | 7.1 | Styrene-acrylic | Styrene-acrylic | 0.0167 | 0.4000 | 0.120 |
| 15 | 15 | 7.0 | Styrene-acrylic | Polyester | 0.0167 | 0.4000 | 0.120 |
| 16 | 16 | 6.7 | Styrene-acrylic | Polyester | 0.0167 | 0.4000 | 0.527 |
| 17 | 17 | 7.1 | Styrene-acrylic | Polyester | 0.0167 | 0.4000 | 0.109 |
| 18 | 18 | 7.3 | Styrene-acrylic | Styrene-acrylic | 0.0118 | 0.4000 | 0.120 |
| 19 | 19 | 7.5 | Styrene-acrylic | Styrene-acrylic | 0.0167 | 0.4000 | 0.120 |
| 20 | 20 | 6.8 | Styrene-acrylic | Styrene-acrylic | 0.0167 | 0.4000 | 0.120 |
| 21 | 21 | 6.9 | Styrene-acrylic | Styrene-acrylic | 0.0167 | 0.4000 | 0.120 |
| 22 | 22 | 7.5 | Styrene-acrylic | Styrene-acrylic | 0.0167 | 0.4000 | 0.120 |
| 23 | 23 | 7.3 | Styrene-acrylic | Styrene-acrylic | 0.0167 | 0.4000 | 0.005 |
| 24 | 24 | 7.2 | Styrene-acrylic | Styrene-acrylic | 0.0167 | 0.4000 | 0.011 |
| 25 | 25 | 7.1 | Styrene-acrylic | Styrene-acrylic | 0.0167 | 0.4000 | 0.071 |
| 26 | 26 | 6.8 | Styrene-acrylic | Styrene-acrylic | 0.0167 | 0.4000 | 2.446 |
| 27 | 27 | 6.7 | Styrene-acrylic | Styrene-acrylic | 0.0167 | 0.4000 | 4.528 |
| 28 | 28 | 6.6 | Styrene-acrylic | Styrene-acrylic | 0.0167 | 0.4000 | 5.870 |
| 29 | 29 | 6.8 | Styrene-acrylic | Styrene-acrylic | 0.0008 | 0.0200 | 2.392 |
| 30 | 30 | 7.3 | Styrene-acrylic | Styrene-acrylic | 0.1111 | 0.5000 | 0.137 |
| 31 | 31 | 6.7 | Styrene-acrylic | Styrene-acrylic | 0.0050 | 0.0075 | 6.377 |
| 32 | 32 | 7.3 | Styrene-acrylic | Styrene-acrylic | 0.0833 | 12.5000 | 0.208 |
| 33 | 33 | 6.9 | Styrene-acrylic | Styrene-acrylic | 0.0833 | 2.0000 | 0.024 |
| 34 | 34 | 7.2 | Styrene-acrylic | Styrene-acrylic | 0.0050 | 0.0150 | 19.712 |
| 35 | 35 | 7.1 | Styrene-acrylic | Styrene-acrylic | 0.0417 | 1.0000 | 0.048 |
| 36 | 36 | 7.0 | Styrene-acrylic | Styrene-acrylic | 0.0083 | 0.0167 | 2.870 |
| 37 | 37 | 7.2 | Styrene-acrylic | Polyurethane | 0.0167 | 0.4000 | 0.174 |
| 38 | 38 | 6.8 | Styrene-acrylic | Styrene-acrylic | 0.0167 | 0.4000 | 0.120 |
| 39 | 39 | 6.7 | Polyester | Styrene-acrylic | 0.0171 | 0.4000 | 0.120 |
| 40 | 40 | 7.5 | Polyester | Styrene-acrylic | 0.0167 | 0.4000 | 0.120 |
| 41 | 41 | 7.6 | Polyester | Polyester | 0.0167 | 0.4000 | 0.120 |
| 42 | 42 | 7.2 | Styrene-acrylic | Styrene-acrylic | — | — | — |
| 43 | 43 | 7.3 | Styrene-acrylic | — | 0.0167 | — | — |
| 44 | 44 | 7.4 | Styrene-acrylic | — | — | — | — |

P¹: polymer segment of formula (1) in resin A
B/A: Content B of fatty acid metal salt (mass %)/content A of wax (mass %)
B/C: Content B of fatty acid metal salt (mass %)/content C of resin A (mass %)
E/F: Moles E of silicon atoms from resin A/moles F of metal of fatty acid metal salt

### Examples 1 to 41 and Comparative Examples 1 to 3

The methods for evaluating the toners 1 to 44 are described below. The evaluation results are shown in Table 5.

<Evaluation of Low-Temperature Fixability>

A modified color laser printer (HP Color LaserJet 3525dn, manufactured by Hewlett-Packard) was prepared with the fixing unit removed as the image-forming apparatus, and the toner was removed from the cyan cartridge and replaced with the toner for evaluation. An unfixed toner image (toner laid-on level 0.9 mg cm²) 2.0 cm long and 15.0 cm wide was then formed with the new toner in a location 1.0 cm from the upper edge in the direction of paper feed on image receiving paper (HP Laser Jet 90, manufactured by Hewlett-Packard, 90 g/m²). Next, the removed fixing unit was modified so that the fixing temperature and process speed could be adjusted and used in a fixing test of the unfixed image.

The process speed was set to 360 mm/s in a normal-temperature, normal-humidity environment (23° C., 60% RH), and the set temperature was raised in 5° C. increments from an initial temperature of 140° C. as the unfixed image was fixed at each temperature.

The standard for evaluating low-temperature fixability is as follows. The low-temperature fixing initiation point is the lowest temperature at which no cold offset phenomenon (in which part of the toner adheres to the fixing unit) is observed.

### Evaluation Standard

A: Low-temperature fixing initiation point of less than 160° C.

B: Low-temperature fixing initiation point of at least 160° C. and less than 180° C.

C: Low-temperature fixing initiation point of at least 180° C. and less than 195° C.

D: Low-temperature fixing initiation point of at least 195° C. and less than 210° C.

E: Low-temperature fixing initiation point of at least 215° C.

In the present disclosure, a rank of A to C indicates good low-temperature fixability.

<Evaluating Offset Resistance>

A modified color laser printer (HP Color LaserJet 3525dn, manufactured by Hewlett-Packard) was prepared with the fixing unit removed as the image-forming apparatus, and the toner was removed from the cyan cartridge and replaced with the toner for evaluation. An unfixed toner image (toner laid-on level 0.9 mg cm²) 2.0 cm long and 15.0 cm wide was then formed with the new toner in a location 1.0 cm from the upper edge in the direction of paper feed on image receiving paper (HP Laser Jet 90, manufactured by Hewlett-Packard, 90 g/m²). Next, the removed fixing unit was modified so that the fixing temperature and process speed could be adjusted and used in a fixing test of the unfixed image.

The process speed was set to 360 mm/s in a normal-temperature, normal-humidity environment (23° C., 60% RH), and the set temperature was raised in 5° C. increments from an initial temperature of 195° C. as the unfixed image was fixed at each temperature.

The evaluation standard for offset resistance is shown below. The maximum fixing temperature is the maximum temperature at which no adhesion of the melted toner to the fixing roller (hot offset) is observed.

### Evaluation Standard

A: Maximum fixing temperature of at least 230° C.

B: Maximum fixing temperature from 220° C. to 225° C.

C: Maximum fixing temperature from 210° C. to 215° C.

D: Maximum fixing temperature from 200° C. to 205° C.

E: Maximum fixing temperature of not more than 195° C.

In the present disclosure, offset resistance is judged to be good if the rank is A to C.

<Evaluation of Flowability (Solid Followability) During Long-Term Use>

To evaluate toner flowability, solid followability was evaluated by the following methods. The greater the flowability of the toner, the better the solid followability.

Using a modified commercial laser printer (HP Color LaserJet Enterprise CP4525dn, manufactured by Hewlett-Packard) an image with a toner laid-on level of 0.40 (mg/cm²) was output at a fixing temperature of 190° C. and a process speed of 360 mm/sec on Canon color laser copy paper.

3 sheets of an all-solid image were output continuously as a sample image in a low-temperature, low-humidity environment (15° C., 10% RH). 20,000 sheets of an image with a print percentage of 0.5% were then output with a pause of 2 seconds between every 2 images. To isolate the effects of component contamination, the drum unit was replaced with a new unit, and 3 sheets of the same all-solid image as in the beginning were output continuously. Solid followability was evaluated visually on the resulting 3 sheets of the all-solid image.

### Solid Followability

### Evaluation Standard

A: Image density uniform, with no irregularity

B: Slight irregularity of image density

C: Some irregularity of image density, but not a problem for use

D: Image density irregular, uniform solid image not obtained

E: Image density blurred, uniform solid image not obtained

In the present disclosure, flowability is judged to be good if the rank is A to C.

<Evaluating Dot Reproducibility>

Using the same apparatus used to evaluate solid followability, dot reproducibility was evaluated by outputting an image with a toner laid-on level of 0.40 (mg/cm²) on the recording medium described below at a fixing temperature of 190° C. and a process speed of 360 mm/sec. Dot reproducibility is improved when the toner charging performance.

10,000 sheets of an A4 test pattern with a print percentage of 1% were output continuously in a high-temperature, high-humidity environment (30° C., 85% RH), after which a halftone image (30H) was formed, and the dot reproducibility of that image was evaluated according to the following standard.

GF-C081 highly white paper (81.4 g/m², Canon Marketing Japan) was used as the recording medium. A 30H image is a halftone image, in which 30H is a value obtained by displaying 256 gradations in hexadecimal notation, with 00H being an all-white image (no image) and FFH a solid image (full-page image).

The areas of 1,000 dots in the resulting halftone image were measured using a VHX-500 digital microscope (VH-Z100 wide-range zoom lens, Keyence Co.).

The number average (S) and standard deviation (a) of the dot areas were calculated, and a dot reproducibility index was calculated by the formula below.

The dot reproducibility of the halftone image was then evaluated based on the dot reproducibility index (I). The smaller the dot reproducibility index (I), the better the dot reproducibility.

Dot reproducibility index (I)=σ/S×100

### Evaluation Standard

A: I is less than 2.0

B: I is from 2.0 to less than 4.0

C: I is from 4.0 to less than 6.0

D: I is from 6.0 to less than 8.0

E: I is at least 8.0

In the present disclosure, dot reproducibility is judged to be good if the rank is from A to C.

<Evaluating Environmental Stability of Toner Charge Quantity>

9.5 g of a magnetic carrier F813-300 (Powdertech Co., Ltd.) and 0.5 g of the toner for evaluation were placed in a 50 c plastic bottle with a lid to make a two-component developer. This two-component developer was left for 24 hours in a high-temperature, high-humidity environment (30° C., 85% RH) or a low-temperature, low-humidity environment (15° C., 10% RH). It was then shaken for 7 minutes at a rate of 150 times/minute in a shaker (YS-LD: Yayoi), and the triboelectric charge quantity in the high-temperature, high-humidity environment and the triboelectric charge quantity in the low-temperature, low-humidity environment were measured with the apparatus shown in the FIGURE. The symbols in the FIGURE are defined as follows: 1 suction apparatus, 2 measurement vessel, 3 screen, 4 lid, 5 vacuum gauge, 6 air volume control valve, 7 suction port, 8 condenser, 9 electrometer.

### Method for Measuring Charge Quantity

0.100 g of the two-component developer to be measured for charge quantity is placed in the metal measurement container 2 shown in the FIGURE, which has a #500 mesh (25 μm) screen 3 at the bottom, and the container is covered with a metal lid 4. The entire weight of the measurement vessel 2 at this point is weighed and given as W1 (g). Next, suction is performed from the suction port 7 of the suction apparatus 1 (in which at least the part contacting the measurement vessel 2 is an insulating body), and the air volume control valve 6 is adjusted so that the pressure at the vacuum gauge 5 is 250 mm Aq. Suction is performed for 2 minutes under these conditions to suction and remove the toner.

The potential of the electrometer 9 here is given as V (volts). 8 here is a condenser with a capacity C (μF). The weight of the entire measurement vessel after suction is weighed and given as W2 (g). The triboelectric charge quantity of the toner is calculated according to the following formula.

Triboelectric charge quantity (μC/g)=(C×V)/(W1−W2)

For the evaluation, the ratio of the triboelectric charge quantity in the high-temperature, high-humidity environment and the triboelectric charge quantity in the low-temperature, low-humidity environment (high-temperature high-humidity triboelectric charge quantity/low-temperature low-humidity triboelectric charge quantity) was calculated. In the present disclosure, environmental stability is judged to be good if the rank is from A to C.

A: High-temperature high-humidity triboelectric charge quantity/low-temperature low-humidity triboelectric charge quantity=at least 0.80

B: High-temperature high-humidity triboelectric charge quantity/low-temperature low-humidity triboelectric charge quantity=at least 0.65 and less than 0.80

C: High-temperature high-humidity triboelectric charge quantity/low-temperature low-humidity triboelectric charge quantity=at least 0.50 and less than 0.65

D: High-temperature high-humidity triboelectric charge quantity/low-temperature low-humidity triboelectric charge quantity=less than 0.50

TABLE 5

| | | Fixing performance | | | | | | | | | | |
|---|---|---|---|---|---|---|---|---|---|---|---|---|
| | | Low-temperature | | Offset | | | Dot | | | | | |
| | | fixability | | resistance | | | reproducibility | | | | | |
| | | | Low-temperature | | Maximum | Flowability | Dot | | Environmental stability | | | |
| | | | fixing | | fixing | Solid | reproducibility | | Triboelectric charge | | | |
| | | | initiation | | temperature | followability | index | | quantity (μC/g) | | | |
| | Toner | Evaluation | point(° C.) | Evaluation | (° C.) | Evaluation | Evaluation | Value | HH | LL | HH/LL | Evaluation |
| Example1 | 1 | A | 145 | A | 240 | A | A | 1.0 | 72 | 80 | 0.90 | A |
| Example2 | 2 | A | 145 | A | 235 | A | A | 1.0 | 60 | 82 | 0.73 | B |
| Example3 | 3 | A | 150 | A | 235 | B | A | 1.2 | 65 | 78 | 0.83 | A |
| Example4 | 4 | A | 150 | A | 235 | B | A | 1.6 | 70 | 79 | 0.89 | A |
| Example5 | 5 | A | 155 | A | 235 | C | A | 1.8 | 62 | 76 | 0.82 | A |
| Example6 | 6 | B | 165 | A | 240 | B | A | 1.7 | 70 | 81 | 0.86 | A |
| Example7 | 7 | C | 180 | A | 245 | C | A | 1.8 | 71 | 81 | 0.88 | A |
| Example8 | 8 | A | 145 | B | 225 | B | A | 1.3 | 67 | 78 | 0.86 | A |
| Example9 | 9 | A | 145 | C | 210 | C | A | 1.8 | 66 | 79 | 0.84 | A |
| Example10 | 10 | A | 155 | A | 235 | B | A | 1.5 | 64 | 77 | 0.83 | A |
| Example11 | 11 | B | 165 | B | 225 | C | A | 1.8 | 64 | 75 | 0.85 | A |
| Example12 | 12 | B | 165 | C | 215 | C | A | 1.8 | 63 | 74 | 0.85 | A |
| Example13 | 13 | A | 145 | A | 235 | A | A | 1.2 | 74 | 80 | 0.93 | A |
| Example14 | 14 | A | 145 | A | 240 | A | A | 1.3 | 66 | 81 | 0.81 | A |
| Example15 | 15 | A | 150 | A | 240 | A | A | 1.4 | 42 | 81 | 0.52 | C |
| Example16 | 16 | A | 150 | A | 235 | B | A | 1.4 | 40 | 78 | 0.51 | C |
| Example17 | 17 | B | 160 | A | 235 | B | A | 1.4 | 45 | 79 | 0.57 | C |
| Example18 | 18 | A | 150 | A | 235 | A | A | 1.2 | 68 | 78 | 0.87 | A |
| Example19 | 19 | A | 155 | A | 235 | A | A | 1.6 | 68 | 80 | 0.85 | A |
| Example20 | 20 | A | 145 | C | 215 | C | A | 1.8 | 65 | 81 | 0.80 | A |
| Example21 | 21 | A | 145 | A | 235 | A | A | 1.7 | 70 | 78 | 0.90 | A |
| Example22 | 22 | B | 170 | A | 240 | A | A | 1.8 | 69 | 77 | 0.90 | A |
| Example23 | 23 | B | 165 | C | 215 | C | C | 4.2 | 66 | 78 | 0.85 | A |
| Example24 | 24 | B | 160 | B | 225 | B | B | 2.7 | 67 | 80 | 0.84 | A |
| Example25 | 25 | A | 155 | A | 235 | B | B | 2.8 | 69 | 81 | 0.85 | A |
| Example26 | 26 | A | 155 | A | 235 | A | A | 1.8 | 67 | 77 | 0.87 | A |
| Example27 | 27 | B | 165 | A | 235 | B | A | 1.8 | 65 | 79 | 0.82 | A |
| Example28 | 28 | C | 185 | A | 235 | C | A | 1.7 | 65 | 82 | 0.79 | B |
| Example29 | 29 | B | 170 | C | 215 | C | A | 1.7 | 64 | 77 | 0.83 | A |
| Example30 | 30 | B | 165 | A | 240 | C | A | 1.2 | 65 | 79 | 0.82 | A |
| Example31 | 31 | B | 175 | C | 215 | C | B | 2.5 | 66 | 80 | 0.83 | A |
| Example32 | 32 | C | 180 | A | 235 | C | A | 1.3 | 65 | 80 | 0.81 | A |
| Example33 | 33 | B | 175 | C | 215 | B | C | 4.8 | 67 | 82 | 0.82 | A |
| Example34 | 34 | B | 170 | B | 225 | B | C | 4.5 | 64 | 77 | 0.83 | A |
| Example35 | 35 | B | 175 | B | 225 | C | C | 4.6 | 68 | 79 | 0.86 | A |
| Example36 | 36 | B | 165 | C | 215 | A | A | 1.8 | 68 | 78 | 0.87 | A |
| Example37 | 37 | A | 155 | A | 235 | B | A | 1.5 | 48 | 80 | 0.60 | C |
| Example38 | 38 | A | 155 | A | 235 | A | A | 1.3 | 69 | 81 | 0.85 | A |
| Example39 | 39 | A | 155 | A | 235 | A | A | 1.2 | 68 | 79 | 0.86 | A |
| Example40 | 40 | A | 150 | A | 235 | B | A | 1.2 | 45 | 82 | 0.55 | C |
| Example41 | 41 | A | 150 | A | 235 | A | A | 1.2 | 68 | 79 | 0.86 | A |
| Comparative | 42 | C | 185 | D | 205 | E | E | 8.3 | 24 | 74 | 0.32 | D |
| Example1 | | | | | | | | | | | | |
| Comparative | 43 | C | 180 | D | 205 | E | D | 7.1 | 22 | 72 | 0.31 | D |
| Example2 | | | | | | | | | | | | |
| Comparative | 44 | B | 165 | E | 190 | E | E | 8.2 | 20 | 75 | 0.27 | D |
| Example3 | | | | | | | | | | | | |

HH: High-temperature high-humidity
LL: Low-temperature low-humidity
HH/LL: High-temperature high-humidity/low-temperature low-humidity

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-178378, filed Oct. 23, 2020, which is hereby incorporated by reference herein in its entirety.

What is claimed is:

1. A toner comprising a toner particle, wherein
the toner particle comprises a binder resin, a resin A, a wax, and a fatty acid metal salt,
the resin A has a substituted or unsubstituted silyl group in a molecule, and
a substituent of the substituted silyl group is at least one selected from the group consisting of an alkyl group having 1 or more carbon atoms, an alkoxy group having 1 or more carbon atoms, a hydroxy group, a halogen atom, and an aryl group having 6 or more carbon atoms.

2. The toner according to claim 1, wherein the resin A has a structure represented by formula (1) below: 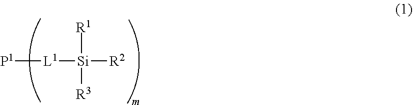
in formula (1), P¹ represents a polymer segment, L¹ represents a single bond or divalent linking group, each of R¹ to R³ independently represents a hydrogen atom, a halogen atom, an alkyl group having 1 or more carbon atoms, an alkoxy group having 1 or more carbon atoms, an aryl group having 6 or more carbon atoms or a hydroxy group, m represents a positive integer, and when m is at least 2, each of the multiple L¹s, each of multiple R's, each of multiple R²s and each of multiple R³s may be the same or different.

3. The toner according to claim 2, wherein at least one of R¹ to R³ in the formula (1) is an alkoxy group having 1 or more carbon atoms or a hydroxy group.

4. The toner according to claim 2, wherein each of R¹ to R³ in the formula (1) independently represents an alkoxy group having 1 or more carbon atoms or a hydroxy group.

5. The toner according to claim 2, wherein P¹ in the formula (1) represents a polyester resin segment or styrene-acrylic resin segment.

6. The toner according to claim 2, wherein a content of a styrene-acrylic resin in the binder resin is at least 50 mass %, and P¹ in the formula (1) represents a styrene-acrylic resin segment.

7. The toner according to claim 2, wherein a content of a polyester resin in the binder resin is at least 50 mass %, and P¹ in the formula (1) represents a polyester resin segment.

8. The toner according to claim 1, wherein a content of silicon atoms in the resin A is 0.02 mass % to 10.00 mass %.

9. The toner according to claim 1, wherein given A mass % as a content of the wax in the toner particle and B mass % as a content of the fatty acid metal salt in the toner particle, a ratio of B to A (B/A) is from 0.0010 to 1.0000.

10. The toner according to claim 1, wherein given B mass % as a content of the fatty acid metal salt in the toner particle and C mass % as a content of the resin A in the toner particle, a ratio of B to C (B/C) is from 0.0100 to 10.0000.

11. The toner according to claim 1, wherein given E as the number of moles of silicon atoms derived from the resin A in the toner particle and F as the number of moles of metal of the fatty acid metal salt in the toner particle, a ratio of E to F (E/F) is from 0.100 to 10.000.

12. The toner according to claim 1, wherein the wax in the toner particle comprises at least one selected from the group consisting of ester waxes and aliphatic hydrocarbon waxes.

13. The toner according to claim 12, wherein
the wax in the toner particle comprises an ester wax, and
the ester wax comprises at least one ester compound selected from the group consisting of:
ester compounds of C₈₋₂₂ fatty acid monomers and alcohol monomers; and
ester compounds of C₈₋₂₂ aliphatic alcohol monomers and acid monomers.

14. The toner according to claim 1, wherein the melting point of the wax in the toner particle is from 60.0° C. to 100.0° C.

15. The toner according to claim 1, wherein the fatty acid metal salt in the toner particle is a metal salt of a fatty acid with at least one metal selected from the group consisting of Al, Mg and Zn.

16. The toner according to claim 1, wherein the fatty acid metal salt in the toner particle is a metal salt of a metal with a C₈₋₂₂ fatty acid.
